(19) United States
(12) Patent Application Publication
(10) Pub. No.: US 2026/0100480 A1
(43) Pub. Date: Apr. 9, 2026

(54) COMPOSITE SEPARATOR, COMPOSITE ELECTROLYTE INCLUDING THE SAME, AND LITHIUM BATTERY INCLUDING THE SAME

(71) Applicant: The Industry & Academic Cooperation in Chungnam National University (IAC), Daejeon (KR)

(72) Inventors: Heesu KIM, Daejeon (KR); Youngmin Moon, Daejeon (KR); Sangbaek Park, Daejeon (KR); Woo-Jin Song, Daejeon (KR); Seung-Wan Song, Daejeon (KR)

(73) Assignee: The Industry & Academic Cooperation in Chungnam National University (IAC), Daejeon (KR)

(21) Appl. No.: 19/336,968

(22) Filed: Sep. 23, 2025

(30) Foreign Application Priority Data
Oct. 4, 2024 (KR) 10-2024-0135054
Jul. 14, 2025 (KR) 10-2025-0094735
Sep. 16, 2025 (KR) 10-2025-0132837

(51) Int. Cl. H01M 50/454; H01M 10/0525; H01M 10/0562; H01M 50/414; H01M 50/44

(52) U.S. Cl. CPC H01M 50/454; H01M 10/0562; H01M 50/414; H01M 50/44; H01M 10/0525; H01M 2300/0071

(57) ABSTRACT

Disclosed are a composite separator and a composite electrolyte and a lithium battery that include the composite separator, the composite separator including a first porous substrate and an ion-conductive composite film on the first porous substrate, wherein the ion-conductive composite film includes an oxide-based solid electrolyte and a first polymer including a carbonyl group, a content of the oxide-based solid electrolyte is greater than 80 wt % relative to the total weight of the oxide-based solid electrolyte and the first polymer, and the first porous substrate includes a plurality of second polymer fibers aligned in a first direction.

### CROSS-REFERENCE TO RELATED APPLICATIONS

This application is based on and claims priority under 35 U.S.C. § 119 to Korean Patent Application Nos. 10-2024-0135054, filed on Oct. 4, 2024, 10-2025-0094735, filed on Jul. 14, 2025, and 10-2025-0132837, filed on Sep. 16, 2025, in the Korean Intellectual Property Office, the disclosures of which are incorporated by reference herein in their entirety.

### BACKGROUND

### 1. Field

The disclosure relates to a composite separator and a composite electrolyte and a lithium battery that include the composite separator.

### 2. Description of the Related Art

Recently, the development of batteries with high energy density and safety has been actively carried out. Lithium batteries are used in a wide range of applications, including information devices, communication devices, automobiles, etc. In lithium batteries, the safety is the biggest concerned.

Lithium batteries using liquid electrolytes have advantages such as excellent ionic conductivity and low interfacial resistance. However, lithium batteries using liquid electrolytes have disadvantages of poor safety in consideration of a high risk of fire and/or explosion in the event of a short circuit.

Meanwhile, lithium batteries using solid electrolytes have disadvantages such as low ionic conductivity and high interfacial resistance. However, lithium batteries using solid electrolytes have advantages of excellent safety in consideration of a low risk of fire and/or explosion in the event of a short circuit.

Lithium metal batteries using lithium metal have a theoretical capacity of 3860 mAh/g, offering the advantage of high energy density. Lithium metal batteries have drawbacks such as lithium dendrite growth and side reactions with liquid electrolytes.

### SUMMARY

An electrolyte including both a solid electrolyte and a polymer has the advantages of increased safety compared a liquid electrolyte, reduced interfacial resistance compared to a solid electrolyte, and improved electrochemical stability compared to a solid electrolyte. However, such an electrolyte including both a solid electrolyte and a polymer has a difficulty in achieving a homogeneous mixture of the solid electrolyte and the polymer, or has disadvantages of degradation due to side reactions between the solid electrolyte and the polymer.

In this regard, there is a demand for a composite electrolyte and/or a composite separator that achieves a homogeneous mixture of the solid electrolyte and the polymer, suppresses side reactions between the solid electrolyte and the polymer, and provides improved safety, reduced interfacial resistance, and improved electrochemical safety.

One aspect is to provide a novel composite separator that exhibits reduced interfacial resistance, improved mechanical properties, improved heat resistance, and improved flame retardancy.

Another aspect is to provide a composite electrolyte exhibiting reduced interfacial resistance and improved electrochemical stability.

Another aspect is to provide a lithium battery having improved characteristics in terms of heat resistance, flame retardancy, and lifespan.

Additional aspects will be set forth in part in the description which follows and, in part, will be apparent from the description, or may be learned by practice of the presented embodiments of the disclosure.

According to an embodiment, a composite separator includes:
a first porous substrate; and an ion-conductive composite film on the first porous substrate,
wherein the ion-conductive composite film includes an oxide-based solid electrolyte and a first polymer including a carbonyl group,
a content of the oxide-based solid electrolyte is greater than 80 wt % relative to the total weight of the oxide-based solid electrolyte and the first polymer, and
the first porous substrate includes a plurality of second polymer fibers aligned in a first direction.

According to another embodiment, a composite electrolyte includes:
the composite separator; and
an electrolyte arranged in the first porous substrate of the composite separator.

According to another embodiment, a lithium battery includes:
a cathode; an anode; and
the composite separator between the cathode and the anode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic cross-sectional view of a composite separator according to an embodiment;

FIG. 2 is a schematic cross-sectional view of a composite separator according to another embodiment;

FIG. 3 is a schematic cross-sectional view of a composite separator according to another embodiment;

FIG. 4 is a schematic cross-sectional view of an oxide-based solid electrolyte according to an embodiment;

FIG. 5 is a schematic view of a lithium battery according to an embodiment;

FIG. 6 is a schematic view of a lithium battery according to an embodiment;

FIG. 7 is a schematic view of a lithium battery according to an embodiment;

FIG. 8 is a schematic view of a lithium battery according to an embodiment;

FIG. 9 shows X-ray diffraction (XRD) spectra of oxide-based solid electrolytes prepared according to Preparation Examples 1 to 6;

FIG. 10A is a scanning electron microscope image of the surface of a first porous substrate including aligned second polymer fibers prepared in Preparation Example 9;

FIG. 10B is a scanning electron microscope image of the surface of a first porous substrate including non-aligned second polymer fibers prepared in Comparative Preparation Example 2;

FIG. 11A is a scanning electron microscope image of a cross-section of a composite separator prepared in Example 1;

FIG. 11B is an energy dispersive spectroscopy (EDS) mapping image of carbon on a cross-section of a composite separator prepared in Example 1;

FIG. 11C is an EDS mapping image of nitrogen on a cross-section of a composite separator prepared in Example 1;

FIG. 11D is an EDS mapping image of lanthanum on a cross-section of a composite separator prepared in Example 1;

FIGS. 12A to 12E are scanning electron microscope images of LLZO solid electrolyte particles prepared in Preparation Example 1;

FIGS. 13A to 13E are scanning electron microscope images of LLZO solid electrolyte particles prepared in Preparation Example 6;

FIGS. 14A to 14C show the results of measuring X-ray photoelectron spectroscopy (XPS) depth profiles on the surface of LLZO solid electrolyte particles prepared in Preparation Example 1;

FIGS. 15A to 15C show the results of measuring XPS depth profiles on the surface of LLZO solid electrolyte particles prepared in Preparation Example 6;

FIGS. 16A to 16D show FT-IR spectra of a LLZO solid electrolyte prepared in Preparation Example 1, an ethylene-vinyl acetate (EVA) polymer used in Preparation Example 7, and ion-conductive composite films prepared in Preparation Examples 7 and 8;

FIGS. 17A to 17C show results of measuring tensile strength for a porous substrate of Comparative Preparation Example 2, a porous substrate of Preparation Example 9, and a composite separator of Example 1.

FIG. 18 is an image showing results of evaluating thermal shrinkage ratios of separators of Comparative Example 1, Preparation Example 9, and Example 1;

FIG. 19 is an image showing results of evaluating flame retardancy of separators of Comparative Example 1, Preparation Example 9, and Example 1;

FIG. 20 is an image showing results of measuring linear sweep voltammetry for a separator of Comparative Example 1, an ion-conductive composite film of Preparation Example 7, a porous substrate of Preparation Example 9, and a composite separator of Example 1;

FIG. 21 is a graph showing results of thermogravimetric analysis for a separator of Comparative Example 1, a PVDF polymer, a PEO polymer, and an EVA polymer; and

FIG. 22 is an image showing results of charge/discharge characteristics for lithium batteries of Example 3 and Comparative Example 3.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terms (including technical and scientific terms) used herein have the same meaning as commonly understood by one or ordinary skill in the art to which this application belongs. Also, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments will be described herein with reference to schematic cross-sectional view of ideal embodiments. As such, variations from the illustrated shape should be expected as a result of, for example, manufacturing techniques and/or tolerances. Thus, example embodiments should not be construed as limited to the particular shapes of regions illustrated herein but are to include deviations in shapes that result, for example, from manufacturing. For example, regions illustrated or described as flat regions may generally have rough and/or non-linear characteristics. Moreover, the angles shown as sharp may be round. Therefore, regions illustrated in drawings are schematic in nature, and shapes thereof are not intended to illustrate the precise shape of the regions and are not intended to limit the scope of the claims.

The present inventive concept may, however, be embodied in many different forms and should not be construed as limited to the embodiments set forth herein. The embodiments are provided so that this disclosure will be thorough and complete, and will fully convey the scope of the present inventive concept to those skilled in the art. Like reference numerals designate like components.

It will be understood that when an element is referred to as being “on” another element, it may be directly on top of the other element, or another element may be interposed therebetween. In contrast, when an element is referred to as being “directly on” another element, there is no intervening element between them.

Although the terms “first,” “second,” “third,” and the like may be used in the disclosure to describe various components, ingredients, regions, layers, and/or zones, these components, ingredients, regions, layers and/or zones should not be limited by these terms. These terms are only used to distinguish one component, ingredient, region, layer or zone from another component, ingredient, region, layer or zone. Thus, a first component, ingredient, region, layer, or zone discussed below could be termed a second component, ingredient, region, layer or zone without departing from the teachings herein.

The terms used herein is for the purpose of describing particular embodiments only and is not intended to be limiting of the present inventive concept. As used herein, the singular form is intended to include the plural form including “at least one” unless the context clearly dictates otherwise. “At least one” should not be construed as limiting to the singular. As used in the disclosure, the term “and/or” includes any and all combinations of one or more of the listed items. The terms “comprises” and/or “comprising” as used in the detailed description specify the presence of specified features, regions, integers, steps, operations, components, and/or ingredients, and one or more other features, regions, integers, steps, operations, components, and/or ingredients. However, it does not exclude the presence or addition thereof.

Spatially relative terms, such as “beneath,” “below,” “lower,” “top,” “above;” “upper,” etc., can be used to facilitate describing the relationship of one component or feature to another component or feature. It will be understood that spatially relative terms are intended to include different orientations of a device in use or operation in addition to the orientations shown in drawings. For example, when a device in drawings is turned over, elements described as “beneath” or “bottom” other elements or features will be oriented “above” the other elements or features. Thus, the exemplary term “below” can encompass both directions of up and down. The device may be otherwise oriented (rotated 90° or rotated in other directions) and the spatially relative descriptors used herein interpreted accordingly.

The “Group” means a group of the Periodic Table of Elements according to the 1 to 18 grouping system of the International Union of Pure and Applied Chemistry (“IUPAC”).

As used in the disclosure, the term “particle diameter” refers to an average diameter of particles if the particles are spherical, and refers to an average major axis length of particles if the particles are non-spherical. The particle diameter may be measured by using a particle size analyzer (PSA). The “particle diameter” refers to, for example, an average particle diameter. The “average particle diameter” may be, for example, a median particle diameter D50.

For example, a median particle diameter D50 refers to a particle size corresponding to a 50% cumulative volume calculated from particles having a small particle size in a particle size distribution measured by, for example, a laser diffraction method.

For example, a median particle diameter D90 refers to a particle size corresponding to a 90% cumulative volume calculated from particles having a small particle size in a particle size distribution measured by, for example, a laser diffraction method.

For example, a median particle diameter D10 refers to a particle size corresponding to a 10% cumulative volume calculated from particles having a small particle size in a particle size distribution measured by, for example, a laser diffraction method.

The term “metal” as used in the disclosure may include both metal and metalloid, such as silicon and germanium, in an elemental state or an ionic state.

The term “alloy” as used in the disclosure may refer to a mixture of two or more metals.

The term “electrode active material” as used in the disclosure may refer to an electrode material capable of undergoing lithiation and delithiation.

The term “cathode active material” as used in the disclosure may refer to a cathode material capable of undergoing lithiation and delithiation.

The term “anode active material” as used in the disclosure may refer to an anode material capable of undergoing lithiation and delithiation.

The terms “lithiation” and “lithiate” as used in the disclosure refer to a process of adding lithium to an electrode active material.

The terms “delithiation” and “delithiate” as used in the disclosure refer to a process of removing lithium from an electrode active material.

The terms “charging” and “charge” as used in the disclosure may refer to a process of providing electrochemical energy to a battery.

The terms “discharging” and “discharge” as used in the disclosure may refer to a process of eliminating electrochemical energy from a battery.

The terms “cathode” and “positive electrode” as used in the disclosure may refer to an electrode in which electrochemical reduction and lithiation occur during a discharge process.

The terms “anode” and “negative electrode” as used in the disclosure may refer to an electrode in which electrochemical oxidation and delithiation occur during a charge process.

While particular embodiments have been described, currently unforeseen or unforeseeable alternatives, modifications, variations, improvements, and substantial equivalents may occur to applicants or those skilled in the art. Accordingly, the appended claims as filed and as may be amended are intended to embrace all such alternatives, modifications, variations, improvements and substantial equivalents.

Hereinafter, according to example embodiments, a composite separator and a composite electrolyte and a lithium battery that include the composite separator will be further described in detail.

### [Composite Separator]

A composite separator according to an embodiment includes: a first porous substrate; and an ion-conductive composite film on the first porous substrate. The ion-conductive composite film includes an oxide-based solid electrolyte and a first polymer including a carbonyl group. A content of the oxide-based solid electrolyte is greater than 80 wt % relative to the total weight of the oxide-based solid electrolyte and the first polymer. The first porous substrate includes a plurality of second polymer fibers aligned in a first direction.

By including the ion-conductive composite film that includes the oxide-based solid electrolyte exceeding 80 wt % and the first polymer including a carbonyl group, the composite separator may provide reduced interfacial resistance, improved mechanical properties, improved heat resistance, and improved flame retardancy.

By including the first polymer including a carbonyl group with high bonding strength to the oxide-based solid electrolyte, the ion-conductive composite film may enable uniform mixing of the oxide-based solid electrolyte and the first polymer, thereby improving mechanical properties of the ion-conductive composite film. Consequently, the composite separator may have improved structural stability. Meanwhile, a polymer including an alkylene oxide repeating unit may have, for example, low bonding strength to an oxide-based solid electrolyte so that it is difficult to achieve a uniform mixture of the oxide-based solid electrolyte and the polymer including an alkylene oxide repeating unit, leading to degradation in mechanical properties of the ion-conductive composite film. Consequently, the composite separator may have degraded structural stability. A fluorine-containing polymer may cause, for example, side reactions with lithium-containing compounds, such as those remaining in the oxide-based solid electrolyte, thereby promoting degradation of the ion-conductive composite film and the composite separator including the same, such as reduced interfacial stability, and reduced ionic conductivity, degraded mechanical properties.

In the ion-conductive composite film, a content of the oxide-based solid electrolyte relative to the total weight of the oxide-based solid electrolyte and the first polymer may be, for example, greater than 80 wt %, 81 wt % or more, 85 wt % or more, 90 wt % or more, 92 wt % or more, 95 wt % or more, or 97 wt % or more. In the ion-conductive composite film, a content of the oxide-based solid electrolyte relative to the total weight of the oxide-based solid electrolyte and the first polymer may be, for example, greater than 80 wt % to about 99 wt %, about 81 wt % to about 99 wt %, about 82 wt % to about 98 wt %, about 83 wt % to about 97 wt %, or about 85 wt % to about 95 wt %. Alternatively, in the ion-conductive composite film, a content of the oxide-based solid electrolyte relative to the total weight of the oxide-based solid electrolyte and the first polymer may be, for example, about 81 wt % to about 99 wt %, about 85 wt % to about 99 wt %, about 90 wt % to about 99 wt %, about 92 wt % to about 99 wt %, about 95 wt % to about 99 wt %, or about 97 wt % to about 99 wt %. When the content of the oxide-based solid electrolyte is within the ranges above in the ion-conductive composite film, the content of organic components such as the first polymer may decrease, thereby further improving mechanical properties, thermal stability, flame retardancy of the ion-conductive composite film and the composite separator including the same. In addition, with the reduced interfacial resistance of the ion-conductive composite film, the ionic conductivity of the ion-conductive composite film and the composite separator including the same may be improved.

When the composite separator includes the first porous substrate with an anisotropic structure including a plurality of second polymer fibers aligned in a first direction, the thermal stability and mechanical properties of the composite separator may be improved.

When the first porous substrate includes the second polymer with excellent heat resistant, the thermal stability of the composite separator may be improved. During thermogravimetric analysis (TGA) of the second polymer, the thermal decomposition temperature may be, for example, 300° C. or more.

The first porous substrate with an anisotropic structure including a plurality of second polymer fibers aligned in a first direction may have, for example, improved mechanical properties in the first direction, as compared to a porous substrate with an isotropic structure. Consequently, the composite separator may have improved structural stability. The first direction may be, for example, a direction intersecting with a thickness direction of the composite separator at an angle of about 30° to about 150°. The first direction may be, for example, a direction perpendicular to a thickness direction of the composite separator.

The composite separator may provide reduced interfacial resistance, improved mechanical properties, improved heat resistance, and improved flame retardancy by including the ion-conductive composite film and the first porous substrate simultaneously.

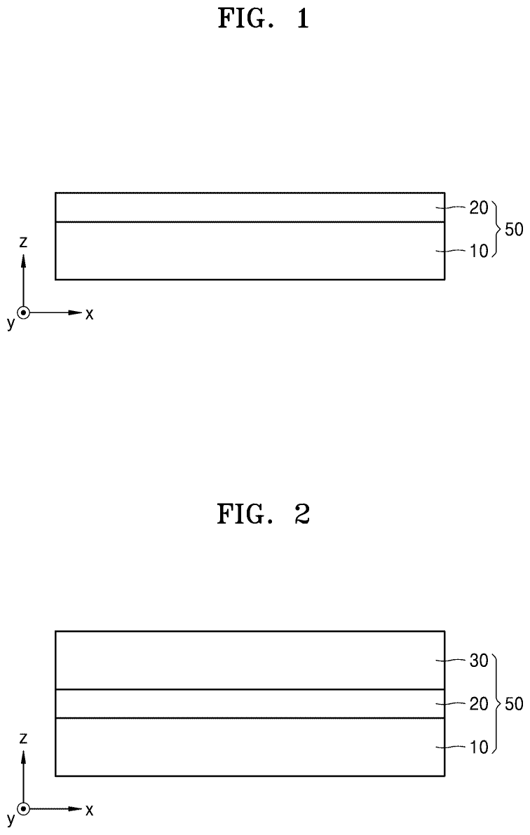

FIG. 1 is a schematic cross-sectional view of the composite separator according to an embodiment.

Referring to FIG. 1, a composite separator 50 includes a first porous substrate 10 and an ion-conductive composite film 20 on one surface of the first porous substrate 10.

The composite separator 50 includes the ion-conductive composite film 20, and the ion-conductive composite film 20 includes an oxide-based solid electrolyte and a first polymer including a carbonyl group.

FIG. 4 is a schematic cross-sectional view of an oxide-based solid electrolyte according to an embodiment.

Referring to FIG. 4, an oxide-based solid electrolyte 500 includes, for example, an oxide-based solid electrolyte core 100 and a coating layer 110 arranged on a surface of the core 100.

When the oxide-based solid electrolyte 500 includes the coating layer 110, the bonding strength between the first polymer and the oxide-based solid electrolyte 500 may be increased. Consequently, the mechanical properties of the ion-conductive composite film 20, which includes the oxide-based solid electrolyte 500 and the first polymer, and the composite separator 50 including the ion-conductive composite film 20 may be further improved.

The coating layer 110 may include, for example, a lithium-containing compound. The lithium-containing compound may include, for example, lithium carbonate (Li₂CO₃), lithium hydroxide (LiOH), or a combination thereof.

The coating layer 110 may be, for example, arranged between the oxide-based solid electrolyte core 100 and the first polymer. the oxide-based solid electrolyte core 100 may be spaced apart from the first polymer by the coating layer 110. The first polymer may be, for example, bonded to the coating layer 110, and consequently, may be bonded to the oxide-based solid electrolyte 500. The coating layer 110 may be, for example, a conformal coating layer arranged along the surface contour of the oxide-based solid electrolyte core 100. Furthermore, the first polymer may be bonded to the coating layer 110 along the surface contour of the coating layer 110. When the oxide-based solid electrolyte 500 includes a conformal coating layer 110, the contact area between the oxide-based solid electrolyte 500 and the first polymer may increase.

In the X-ray photoelectron spectroscopy (XPS) depth profile measurement of the surface of the oxide-based solid electrolyte 500, for example, at the start of sputtering, a second oxygen peak derived from lattice oxygen (O_{lattice}) of the oxide-based solid electrolyte appearing at 527.5 eV to 530 eV may be free. In the XPS depth profile measurement of the surface of the oxide-based solid electrolyte 500, for example, at the initial ion-sputtering, the oxide-based solid electrolyte core 100 is completely coated with the coating layer 110 such that the oxide-based solid electrolyte core 100 may not be exposed to the surface of the oxide-based solid electrolyte 500. Accordingly, the second oxygen peak derived from the oxide-based solid electrolyte core 100 may be free.

In the XPS depth profile measurement of the surface of the oxide-based solid electrolyte 500, for example, after 130 seconds, 260 seconds, 390 seconds, 520 seconds, or 650 seconds from the start of ion-sputtering, a ratio (P2/P1) of the intensity (P2) of a second oxygen peak derived from lattice oxygen (O_{lattice}) of the oxide-based solid electrolyte appearing at 527.5 eV to 530 eV to the intensity (P1) of a first oxygen peak derived from lithium carbonate (Li₂CO₃) appearing at 530 eV to 532.5 eV may be 1 or less. The ion-sputtering may be, for example, performed by using Ar⁺ ion beams. The energy range of the ion-sputtering may be, for example, in a range of about 100 eV to about 4 keV, and the maximum ion-beam current may be, for example, in a range of about 3 keV to about 4 μA.

In the XPS depth profile measurement of the surface of the oxide-based solid electrolyte 500, for example, even after etching in the depth direction for 130 seconds, 260 seconds, 390 seconds, 520 seconds, or 650 seconds from the start of ion-sputtering, the oxide-based solid electrolyte core 100 is coated with the coating layer 110, and in this regard, the ratio (P2/P1) of the intensity (P2) of a second oxygen peak derived from lattice oxygen (O_{lattice}) of the oxide-based solid electrolyte appearing at 527.5 eV to 530 eV to the intensity (P1) of a first oxygen peak derived from lithium carbonate (Li₂CO₃) may be 1 or less. A thick coating layer 110 may be arranged on the oxide-based solid electrolyte core 100.

In the XPS depth profile measurement of the surface of the oxide-based solid electrolyte 500, for example, even after etching in the depth direction for 130 seconds to 780 seconds, 260 seconds to 780 seconds, 390 seconds to 780 seconds, 520 seconds to 780 seconds, or 650 seconds to 780 seconds from the start of the ion-sputtering, the oxide-based solid electrolyte core 100 is coated with the coating layer 110, and in this regard, the ratio (P2/P1) of the intensity (P2) of a second oxygen peak derived from lattice oxygen (O_{lattice}) of the oxide-based solid electrolyte appearing at 527.5 eV to 530 eV to the intensity (P1) of a first oxygen peak derived from lithium carbonate (Li₂CO₃) may be 1 or less. A thick coating layer 110 may be arranged on the oxide-based solid electrolyte core 100.

In the XPS depth profile measurement of the surface of the oxide-based solid electrolyte 500, for example, after 130 seconds, 260 seconds, 390 seconds, 520 seconds, or 650 seconds from the start of ion-sputtering, the intensity (P1) of a first oxygen peak derived from a lithium carbonate-containing coating layer may be greater than the intensity (P2) of a second oxygen peak derived from lattice oxygen of the oxide-based solid electrolyte.

In the XPS depth profile measurement of the surface of the oxide-based solid electrolyte 500, for example, after 130 seconds to 780 seconds, 260 seconds to 780 seconds, 390 seconds to 780 seconds, 520 seconds to 780 seconds, or 650 seconds to 780 seconds from the start of ion-sputtering, the intensity (P1) of a first oxygen peak derived from a lithium carbonate-containing coating layer may be greater than the intensity (P2) of a second oxygen peak derived from lattice oxygen of the oxide-based solid electrolyte.

When the oxide-based solid electrolyte 500 includes such a thick coating layer 110, a first polymer binder including a carbonyl group may be bonded more strongly to the oxide-based solid electrolyte 500.

A thickness of the coating layer 110 may be, for example, in a range of about 3 nm to about 100 nm, about 5 nm to about 50 nm, about 10 nm to about 40 nm, about 15 nm to about 35 nm, or about 20 nm to about 30 nm. When the thickness of the coating layer 110 is within the ranges above, the bonding between the oxide-based solid electrolyte 500 and the first polymer may be maintained more strongly. Consequently, the mechanical properties of the ion-conductive composite film 20, which includes the oxide-based solid electrolyte 500 and the first polymer, and the composite separator 50 including the ion-conductive composite film 20 may be further improved.

When the coating layer 110 is excessively thin, the bonding strength between the oxide-based solid electrolyte 500 and the first polymer may be relatively reduced. When the coating layer 110 is excessively thick, the overall ionic conductivity of the composite separator 50 may be reduced due to an excessive increase in the content of the lithium carbonate. The thickness of the coating layer 110 may be, for example, measured by a scanning electron microscope (SEM) or a transmission electron microscope (TEM).

The oxide-based solid electrolyte 500 may be, for example, oxides or phosphates including lithium and 2 or more types of metals other than lithium.

The oxide-based solid electrolyte 500 may be, for example, a crystalline solid electrolyte or an amorphous solid electrolyte.

The oxide-based solid electrolyte 500 may include, for example, a garnet-type solid electrolyte, a NASICON-type solid electrolyte, a LISICON-type solid electrolyte, a perovskite-type solid electrolyte, a LiPON-type solid electrolyte, an amorphous solid electrolyte, or a combination thereof.

The garnet-type solid electrolyte may include a lithium-lanthanum-zirconium-oxide (LLZO) represented by Li₃₊ₓLa_{y}M_{z}O₁₂ (where 1≤x≤10, 2≤y≤4, 1≤z≤3, M is Zr, Ga, W, Nb, Ta, Al, or a combination thereof). The garnet-type solid electrolyte may include, for example, Li₇La₃Zr₂O₁₂, Li₃₊ₓLa₃Zr₂₋ₐMₐO₁₂ (M doped LLZO, M=Ga, W, Nb, Ta, Al or a combination thereof, 1≤x≤10, 0<a<2), and the like.

The NASICON-type solid electrolyte may include, for example, lithium-aluminum-transition metal-phosphate (LAMP) represented by Li₁₊ₓAlₓM₂₋ₓ(PO₄)₃ (where 0<x<2, M is Zr, Ti, Ge or a combination thereof). The NASICON-type solid electrolyte may include, for example, Li₁₊ₓAlₓTi₂₋ₓ(PO₄)₃ (where 0<x<1) to which Ti as a transition metal is introduced, lithium-aluminum-titanium-phosphate (LATP), such as Li_{1.3}Al_{0.3}Ti_{1.7}(PO₄)₃ to which excessive lithium is introduced, lithium-aluminum-germanium-phosphate (LAGP) represented by Li₁₊ₓAlₓGe₂₋ₓ(PO₄)₃ (where 0<x<1), lithium-zirconium-phosphate (LZP) represented by LiZr₂(PO₄)₃, and the like.

The LISICON-type solid electrolyte may be, for example, represented by xLi₃AO₄-(1−x)Li₄BO₄ (where A is P, As, or V, and B is Si, Ge, or Ti). The LISICON-type solid electrolyte may include, for example, a solid solution oxide such as Li₄Zn(GeO₄)₄, Li₁₀GeP₂O₁₂ (LGPO), Li_{3.5}Si_{0.5}P_{0.5}O₄, Li_{10.42}Si(Ge)_{1.5}P_{1.5}Cl_{0.08}O_{11.92}, and the like.

The perovskite-type solid electrolyte may include lithium lanthanum titanate (LLTO) represented by Li₃ₓLa_{2/3-x1/3-2x}TiO₃ (where 0<x<0.16). The perovskite-type solid electrolyte may include, for example, Li_{1/8}La_{5/8}TiO₃ and the like.

The LIPON-type solid electrolyte may include a oxynitride such as lithium-phosphorus-oxynitride (LIPON). The LIPON-based solid electrolyte may include, for example, a oxynitride such as Li_{2.8}PO_{3.3}N_{0.46}.

The amorphous solid electrolyte may include Li₂O—B₂O₃—SiO₂, Li₂O—B₂O₃—P₂O₅, Li₃BO₃—Li₂SO₄, or Li₃BO₃—Li₂CO₃.

The oxide-based solid electrolyte 500 may include, for example, Li_{1+x+y}AlₓTi₂₋ₓSi_{y}P_{3-y}O₁₂ (where 0<x<2, and 0≤y<3), LiₓTi_{y}(PO₄)₃ (where 0<x<2, and 0<y<3), LiₓAl_{y}Ti_{z}(PO₄)₃ (where 0<x<2, 0<y<1, and 0<z<3), Li_{1+x+y}(Al, Ga)ₓ(Ti, Ge)₂₋ₓSi_{y}P_{3-y}O₁₂ (where 0≤x≤1, and 0≤y≤1), LiₓLa_{y}TiO₃ (where 0<x<2, and 0<y<3), Li₂O—Al₂O₃—SiO₂—P₂O₅—TiO₂—GeO₂, Li₃₊ₓLa₃M₂O₁₂ (where M is Te, Nb, or Zr, and x is an integer from 1 to 10), and the like.

The oxide-based solid electrolyte 500 may include, for example, LLZO, LATP, LLTO, LAGP, or a combination thereof.

In the LLZO, for example, a lithium content per mol of the LLZO may be 6.8 mol or more, 6.85 mol or more, 6.90 mol or more, 6.97 mol or more, or 7.0 mol or more.

In the LLZO, for example, a lithium content per mol of the LLZO may be in a range of about 6.8 mol to about 10 mol, about 6.85 mol to about 9 mol, about 6.90 mol to about 8 mol, about 6.97 mol to about 8 mol, or about 7.0 mol to about 8 mol.

When the LLZO includes such a high lithium content, the ionic conductivity of the ion-conductive composite film including the LLZO and the composite separator including the ion-conductive composite film may be further improved. In addition, by increasing the bonding strength between the LLZO and the first polymer, the mechanical properties of the ion-conductive composite film and the composite separator including the same may be further improved. The lithium content in the LLZO may be, for example, measured by ICP-AES.

The oxide-based solid electrolyte 500 may include, for example, a garnet-type oxide. The garnet-type oxide may include, for example, a cubic phase. When the garnet-type oxide includes a cubic phase, the improved ionic conductivity may be provided.

The garnet-type oxide may be, for example, represented by Formula 1:

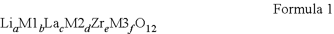

wherein, in the formulae above,
M1 may be H, Fe, Ga, Al, B, Be, or a combination thereof,
M2 may be Ba, Ca, Sr, Y, Bi, Pr, Nd, Ac, Sm, Gd, or a combination thereof,
M3 may be Al, Ga, Ta, Nb, Hf, Ti, V, Cr, Co, Ni, Cu, Mo, W, Mg, Tc, Pd, Sc, Cd, In, Sb, Te, Tl, Pt, Si, Ir, Ru, Mn, Sn, or a combination thereof, and
6≤a≤8, 0≤b<2, 2.5≤c≤3.5, 0≤d<0.2, 1.5≤e≤2.5, and 0≤f<1.

In the formula above, for example 6.1≤a≤8, 6.2≤a≤8, 6.3≤a≤8, 6.4≤a≤8, 6.5≤a≤8, 6.6≤a≤8, 6.7≤a≤8, 6.8≤a≤8, 6.9≤a≤8, or 7.0≤a≤8.

In the formula above, for example 2.5≤c≤3.5, 2.8≤c≤3.2, or 2.9≤c≤3.1.

In the formula above, for example 1.5≤e≤2.5, 1.8≤e≤2.2, or 1.8≤e≤2.0. The oxide-based solid electrolyte 500 may have, for example, a particle shape.

The oxide-based solid electrolyte 500 may include, for example, particles of the oxide-based solid electrolyte 500. A particle diameter of the particles of the oxide-based solid electrolyte 500 may be, for example, in a range of about 1 μm to about 50 μm, about 1 μm to about 40 μm, about 1 μm to about 30 μm, about 1 μm to about 20 μm, or about 1 μm to about 10 μm. When the particle diameter of the oxide-based solid electrolyte 500 is within the ranges above, the oxide-based solid electrolyte 500 may be bonded to the first polymer more strongly.

The particle diameter of the oxide-based solid electrolyte 500 may be, for example, an arithmetic mean of particle diameters from a scanning electron microscope image calculated manually or using a software. Alternatively, the particle diameter of the oxide-based solid electrolyte 500 may be, for example, measured by a laser diffraction method using a particle size analyzer (PSA).

Referring to FIG. 1, the composite separator 50 includes the ion-conductive composite film 20, and the ion-conductive composite film 20 includes the oxide-based solid electrolyte and the first polymer including a carbonyl group.

The first polymer may include, for example, an ester group-containing polymer, an amide group-containing polymer, or a combination thereof. The ester group and the amide group may each include a carbonyl group within the molecule structure.

When the first polymer includes such polymers, the first polymer may be bonded to the oxide-based solid electrolyte more strongly, thereby improving the mechanical properties of the ion-conductive composite film 20 including the first polymer and the composite separator 50 including the ion-conductive composite film 20.

The first polymer may be, for example, a non-fluorinated polymer. The first polymer may not include a fluorine atom. Since the first polymer is a non-fluorinated polymer, generation of lithium salts, moisture, etc., by side reactions between fluorine and lithium-containing compounds may be prevented. These side reactions may lead to reduced interfacial stability of the composite separator 50, thereby reducing the ionic conductivity and degrading the mechanical properties.

The first polymer may be, for example, a polymer containing a non-ether group. The first polymer may not include an ether group. The polymer containing a non-ether group may be, for example, a polymer containing a non-alkylene oxide group. The first polymer may not include, for example, an alkylene oxide group such as an ethylene oxide group.

A polymer containing an alkylene oxide group exhibits weak bonding with the oxide-based solid electrolyte, thereby deteriorating the mechanical properties of the ion-conductive composite film 20, which includes the polymer including an alkylene oxide group, and the composite separator 50 including the ion-conductive composite film 20.

The first polymer may include, for example, an acetate-based polymer, an acrylic-based polymer, a urethane-based polymer, or a combination thereof. The first polymer may include, for example, ethylene-vinyl acetate (EVA), polyvinyl acetate (PVAc), polyurethane (PU), poly(methyl methacrylate) (PMMA), polyethylene terephthalate (PET), or a combination thereof. The first polymer may be, for example, a copolymer. When the first polymer is a copolymer, more improved properties may be provided. During the TGA of the first polymer, the thermal decomposition temperature may be, for example, 300° C. or more, 330° C. or more, or 350° C. or more. When the first polymer has such a high thermal decomposition temperature, the ion-conductive composite film 20 including the first polymer and the composite separator 50 including the ion-conductive composite film 20 may provide improved thermal stability.

The ion-conductive composite film 20 may be, for example, a free-standing film. When the ion-conductive composite film 20 is a free-standing film, handling of the ion-conductive composite film 20 may be facilitated. For example, the manufacture of the composite separator 50 including the ion-conductive composite film 20 may be achieved more easily.

The ion-conductive composite film 20 may be, for example, a flexible free-standing film. When the ion-conductive composite film 20 is a flexible free-standing film, the composite separator 50 including the ion-conductive composite film 20 may also be a flexible free-standing film. Accordingly, the composite separator 50 may be readily applied to batteries of various structures.

The composite separator 50 includes the ion-conductive composite film 20, and the ion-conductive composite film 20 may be, for example, arranged adjacent to an anode, for example, a lithium metal, within a lithium battery.

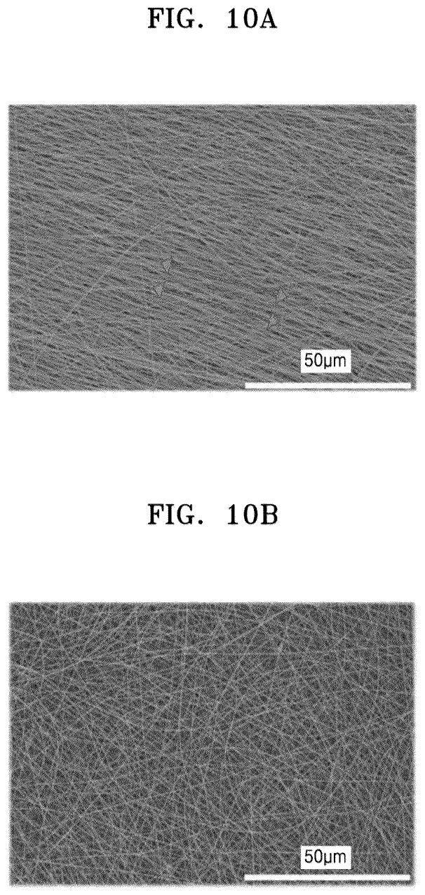

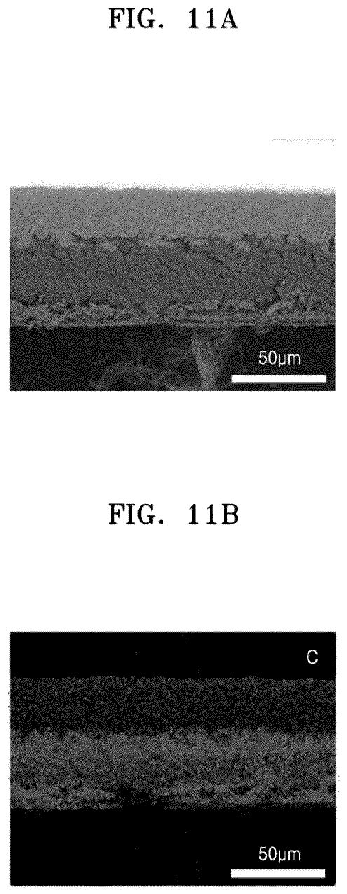

Referring to FIG. 1, the composite separator 50 includes the first porous substrate 10. FIG. 10A is a scanning electron microscope image of the surface of the first porous substrate 10 including aligned second polymer fibers prepared in Preparation Example 9. FIG. 10B is a scanning electron microscope image of the surface of the first porous substrate 10 including non-aligned second polymer fibers prepared in Comparative Preparation Example 2.

Referring to FIGS. 1 and 10A, the first porous substrate 10 may have, for example, an anisotropic structure. The first porous substrate 10 may include, for example, a plurality of second fiber polymers aligned in a first direction (the direction of the arrow in FIG. 10A). The first porous substrate 10 may include, for example, a porous nonwoven web with an anisotropic structure including the plurality of second polymer fibers aligned in the first direction. The porous nonwoven web including the plurality of second polymer fibers aligned in the first direction may be, for example, prepared by electrospinning. Referring to FIG. 10B, a porous substrate in the art may have, for example, an isotropic structure. The porous substrate in the art may include, for example, a porous nonwoven web with an isotropic structure including a plurality of polymer fibers that are not aligned. Alternatively, the porous substrate in the art may have a porous structure with an isotropic structure including a plurality of pores formed by elongation or the like.

Referring to FIGS. 1 and 10A, the first porous substrate 10 including the porous nonwoven web with an anisotropic structure including the plurality of second polymer fibers aligned in the first direction may have, for example, improved mechanical properties in the first direction, as compared to the porous substrate having an isotropic structure. Consequently, the first porous substrate 10 and the composite separator 50 including the same may have improved structural stability.

The first direction may be, for example, a direction intersecting with the thickness direction (z-direction in FIG. 1) of the first porous substrate 10 and the composite separator 10 including the same, at an angle of about 30° to about 150°, about 45° to about 135°, or about 60° to about 120°. The first direction may be, for example, a direction perpendicular to the thickness direction of the first porous substrate 10 and the composite separator 50 including the same. Referring to FIG. 1, the first direction may be, for example, the x-direction.

The second polymer fiber may include, for example, polyacrylonitrile (PAN), polyimide (PI), polyamide-imide (PAI), polyvinylidene fluoride (PVDF), polyvinylidene fluoride-hexafluoropropylene copolymer (PVDF-HFP), or a combination thereof. When the second polymer fiber includes these polymers, the thermal stability and mechanical properties of the first porous substrate 10 may be further improved.

A diameter of the second polymer fiber may be, for example, in a range of about 10 nm to about 1000 nm, about 10 nm to about 500 nm, about 50 nm to about 500 nm, about 100 nm to about 500 nm, about 100 nm to about 400 nm, or about 150 nm to about 350 nm. When the diameter of the second polymer fiber is within the ranges above, the mechanical properties of the first porous substrate 10 may be further improved. The diameter of the second polymer fiber may be, for example, an arithmetic mean value calculated from a scanning electron microscope image of the first porous substrate 10 using a software.

A tensile strength of the first porous substrate 10 in the first direction may be 50 MPa or more, 60 MPa or more, 70 MPa or more, or 75 MPa or more. When the tensile strength of the first porous substrate 10 is within the ranges above, the structural stability of the first porous substrate 10 and the composite separator 50 including the same may be further improved. The tensile strength may be, for example, measured using a universal test machine.

The tensile strength of the composite separator 50 in the first direction may be 40 MPa or more, 50 MPa or more, or 55 MPa or more. When the tensile strength of the composite separator 50 is within the ranges above, the structural stability of the composite separator 50 may be further improved. The tensile strength may be, for example, measured using a universal test machine.

Referring to FIG. 1, the composite separator 50 includes the first porous substrate 10 and the ion-conductive composite film 20, and a thickness ratio (T1/T2) of a thickness (T1) of the first porous substrate 10 to a thickness (T2) of the ion-conductive composite film 20 may be greater than 1 or may be 1.1 or more, 1.5 or more, or 2 or more. When the thickness ratio (T1/T2) of the thickness of the first porous substrate 10 to the thickness (T2) of the ion-conductive composite film 20 is within the ranges above, the structural stability of the composite separator 50 may be further improved.

The thickness of the ion-conductive composite film 20 may be, for example, in a range of about 5 μm to about 50 μm, 10 μm to about 50 μm, about 10 μm to about 40 μm, or about 10 μm to about 30 μm. When the thickness of the ion-conductive composite film 20 is within the ranges above, the structural stability of the composite separator 50 may be further improved. The thickness of the first porous substrate 10 may be, for example, in a range of about 20 μm to about 100 μm, about 25 μm to about 80 μm, about 30 μm to about 70 μm, or about 40 μm to about 60 μm. When the thickness of the first porous substrate 10 is within the ranges above, the structural stability of the composite separator 50 may be further improved. The thickness of the composite separator 50 may be, for example, in a range of about 30 μm to about 150 μm, about 50 μm to about 100 μm, or about 60 μm to about 80 μm. When the thickness of the composite separator 50 is within the ranges above, both structural stability and flexibility may be improved simultaneously.

FIG. 2 is a schematic cross-sectional view of the composite separator 50 according to another embodiment.

Referring to FIG. 2, the composite separator 50 further includes a second porous substrate 30. The second porous substrate 30 may include a plurality of second polymer fibers aligned in a second direction distinct from the first direction. The angle between the first direction and the second direction may be, for example, in a range of about 45° to about 135°, about 60° to about 120°, or about 75° to about 105°. Referring to FIG. 2, for example, the first direction may be an x-direction, and the second direction may be a y-direction. When the angle between the first direction and the second direction is within the ranges above, the mechanical properties and/or structural stability of the composite separator 50 may be further improved. By having the aforementioned structure, the structural stability of the composite separator 50 may be further improved.

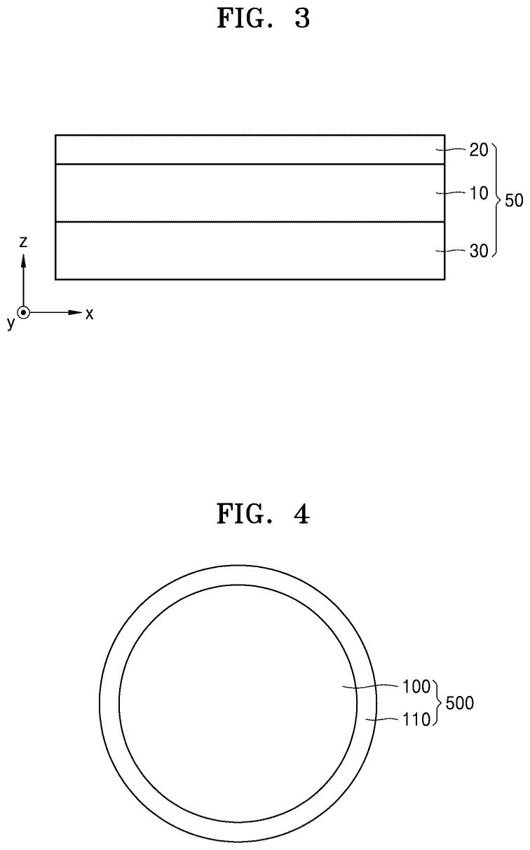

FIG. 3 is a schematic cross-sectional view of the composite separator 50 according to another embodiment.

In the composite separator 50, the second porous substrate 30 may be arranged on one surface of the ion-conductive composite film 20. In the composite separator 50, for example, the first porous substrate 10 may be arranged on one surface of the ion-conductive composite film 20, and the second porous substrate 30 may be arranged on the other surface of the first porous substrate 10. By having the aforementioned structure, the structural stability of the composite separator 50 may be further improved.

Referring to FIGS. 1 to 3, a porosity of the ion-conductive composite film 20 may be, for example, 30% less than or 25% or less. The ion-conductive composite film 20 has low porosity, but may provide excellent ionic conductivity by including the oxide-based solid electrolyte and the first polymer containing the carbonyl group. A porosity of the first porous substrate 10 may be, for example, 30% or more, 40% or more, or 50% or more. When the first porous substrate 10 has high porosity, the first porous substrate may contain, for example, a liquid electrolyte more effectively, thereby providing improved ionic conductivity. A porosity of the composite separator 50 may be 50% or less, 45% or less, 40% or less, 35% or less, or 30% or less. When the composite separator 50 includes the ion-conductive composite film 20, the composite separator 50 may have such low porosity. The porosity of the ion-conductive composite film 20, the first porous substrate 10, and/or the composite separator 50 may be, for example, measured by a gas adsorption method. Alternatively, the porosity of the ion-conductive composite film 20, the first porous substrate 10, and/or the composite separator 50 may be calculated by measuring the volume and weight of each of the ion-conductive composite film 20, the first porous substrate 10, and the composite separator 50, in consideration of the theoretical density of materials constituting the ion-conductive composite film 20, the first porous substrate 10, and the composite separator 50. Alternatively, the porosity of the ion-conductive composite film 20, the first porous substrate 10, and/or the composite separator 50 may be calculated by a liquid displacement method. Liquid used herein may be, for example, butanol. For example, after impregnating each of the ion-conductive composite film 20, the first porous substrate 10, and/or the composite separator 50 may be immersed with liquid, the density of the liquid and the composite separator 50 may be calculated from the resulting weight difference.

The porosity may be, for example, calculated by Equation A:

$$Porosity ( \% ) = {W}_{l} / {ρ}_{l} / ( Wl / {ρ}_{l} + {W}_{s} / {ρ}_{s} ) \times 100 \qquad Equation A$$

wherein Wₗ indicates a liquid weight, Wₛ indicates a weight of dried separator, μₗ indicates liquid density, and ρₛ indicate separator density.

Referring to FIGS. 1 to 3, the thermal shrinkage ratio of the composite separator 50 after 20-minute exposure at 180° C. may be, for example, 3% or less, 2% or less, or 1% or less. Accordingly, the composite separator 50 may provide improved thermal stability. The thermal shrinkage ratio is the percentage of the area of the composite separator 50 after exposure to high temperatures relative to the area of the composite separator 50 before exposure to high temperature. A method of measuring the thermal shrinkage ratio may be referred to Evaluation Example 5. When the composite separator 50 includes the ion-conductive composite film 20 including the oxide-based solid electrolyte and the first porous substrate 10 including the second fibers with excellent thermal stability, the composite separator 50 may have excellent thermal stability.

Referring to FIGS. 1 to 3, the ionic conductivity of the composite separator 50 may be, for example, 0.5 mS/cm or more, 0.7 mS/cm or more, or 0.8 mS/cm or more at 25° C. and 1 atm. When the composite separator 50 has such high ionic conductivity, the charge/discharge characteristics of a lithium battery including the composite separator 50 may be further improved. The ionic conductivity of the composite separator 50 may be, for example, measured by electrochemical impedance spectroscopy (EIS).

Referring to FIGS. 1 to 3, the electrochemical stability voltage window of the composite separator 50 with oxidation current of 10 μA or less may be, for example, 4.5 V (vs. Li) or more, 4.7 V (vs. Li) or more, or 5.0 V (vs. Li) or more. When the composite separator 50 has a such a wide range of the electrochemical stability voltage window, the composite separator 50 may be readily applied to a lithium battery with various operating potentials. A method of measuring the voltage window may be referred to Evaluation Example 8.

### [Composite Electrolyte]

According to another embodiment, the composite electrolyte includes: the composite separator; and an electrolyte arranged on the first porous substrate of the composite separator.

When the composite electrolyte includes the composite separator and the electrolyte on the first porous substrate, improved structural stability and excellent ionic conductivity may be provided.

The electrolyte arranged on the first porous substrate may be impregnated within the first porous substrate.

The electrolyte arranged on the first porous substrate may include, for example, a liquid electrolyte, a solid electrolyte, a gel electrolyte, or a combination thereof.

The liquid electrolyte may include, for example, an organic solvent and a lithium salt. For use as the organic solvent, any material available as the organic solvent in the art may be used. Examples of the organic solvent are propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyl dioxolan, N, N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, or a mixture thereof. organic solvent may be, for example, propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, Y-butyrolactone, dioxolane, N, N-dimethylformamide, dimethylacetamide, dimethylsulfoxide, dioxane, 1,2-dimethoxyethane, sulfolane, dichloroethane, chlorobenzene, nitrobenzene, diethylene glycol, dimethylether, or a mixture thereof. For use as the lithium salt, any material available as the lithium salt in the art may be also used. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LlN(CₓF₂ₓ₊₁SO₂) (C_{y}F_{2y+1}SO₂) (where x and y are natural numbers), LiCl, Lil, or a mixture thereof.

The solid electrolyte may include, for example, a polymer solid electrolyte.

The polymer solid electrolyte may include, for example, a mixture of a lithium salt and a polymer, or a polymer including an ion-conducting functional group. The polymer solid electrolyte may be, for example, a polymer electrolyte in a solid state at 25° C. and 1 atm. The polymer solid electrolyte may not include, for example, liquid. The polymer of the polymer solid electrolyte may include, for example, polyethylene oxide (PEO), polyvinylidene fluoride (PVDF), vinylidene fluoride-hexafluoropropylene (PVDF-HFP), a poly(styrene-b-ethylene oxide) block copolymer (PS-PEO), poly(styrene-butadiene), poly(styrene-isoprene-styrene), a poly(styrene-b-divinylbenzene) block copolymer, a poly(styrene-ethylene oxide-styrene) block copolymer, polystyrene sulfonate (PSS), polyvinyl fluoride (PVF), poly(methylmethacrylate) (PMMA), polyethylene glycol (PEG), polyacrylonitrile (PAN), polytetrafluoroethylene (PTFE), polyethylene dioxythiophene (PEDOT), polypyrrole (PPY), polyaniline, polyacetylene, nafion, aquivion, flemion, gore, aciplex, morgane ADP, sulfonated poly(ether ketone) (SPEEK), sulfonated poly(arylene ether ketone sulfone) (SPAEKKS), sulfonated poly(aryl ether ketone) (SPAEK), poly[bis(benzimidazobenzisoquinolinones)] (SPBIBI), lithium 9,10-diphenylanthracene-2-sulfonate (DPASLi⁺), or a combination thereof, but is not limited thereto. Any material available as the polymer electrolyte in the art may be used. For use as the lithium salt, any material available as the lithium salt in the art may be used. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LlN(CₓF₂ₓ₊₁SO₂) (C_{y}F_{2y+1}SO₂) (where x and y may each be between 1 to 20), LiCl, Lil, or a mixture thereof. The polymer included in the polymer solid electrolyte may be, for example, a compound including 10 or more, 20 or more, 50 or more, or 100 or more repeating units. The polymer included in the polymer solid electrolyte may have a weight average molecular weight of, for example, 1,000 dalton (Da) or more, 10,000 Da or more, 100,000 Da or more, or 1,000,000 Da or more.

The gel electrolyte may be, for example, a polymer gel electrolyte. The gel electrolyte may be in a gel state without including a polymer.

The polymer gel electrolyte may include, for example, a liquid electrolyte and a polymer, or an organic solvent and a polymer having an ion-conductive functional group. The polymer gel electrolyte may be, for example, in a gel state at 25° C. and at 1 atm. The polymer gel electrolyte may be, for example, in a gel state without including liquid. The liquid electrolyte used in the polymer gel electrolyte may be, for example, a mixture of ionic liquid, a lithium salt, and an organic solvent; a mixture of a lithium salt and an organic solvent; a mixture of ionic liquid and an organic solvent; or a mixture of a lithium salt, ionic liquid, and an organic solvent. The polymer used in the polymer gel electrolyte may be selected from polymers used in the polymer solid electrolyte. The organic solvent may be selected from organic solvents used in liquid electrolytes. The lithium salt may be selected from lithium salts used in polymer solid electrolytes. The ionic liquid may refer to a salt in a liquid state, and a molten salt at room temperature consisting solely of ions and having a melting point below room temperature. The ionic liquid may include, for example, one or more selected from compounds including: a) one or more cations selected from an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-based cation, a phosphonium-based cation, a sulfonium-based cation, a triazolium-based cation, and a mixture thereof; and b) one or more anions selected from BF₄₋, PF₆₋, AsF₆₋, SbF₆₋, AlCl₄₋, HSO₄²⁻, ClO₄₋, CH₃SO₃₋, CF₃CO₂₋, Cl, Br, I, CF₃SO₃₋, (FSO₂)₂N, (C₂F₅SO₂)₂N⁻, (C₂F₅SO₂)(CF₃SO₂)N⁻, and (CF₃SO₂)₂N⁻. The polymer solid electrolyte may be impregnated with a liquid electrolyte in a secondary battery to form a polymer gel electrolyte. The polymer gel electrolyte may further include inorganic particles. The polymer included in the polymer gel electrolyte may be, for example, a compound including 10 or more, 20 or more, 50 or more, or 100 or more repeating units. The polymer included in the polymer gel electrolyte may have a weight average molecular weight of, for example, 500 Da or more, 1,000 Da or more, 10,000 Da or more, 100,000 Da or more, or 1,000,000 Da or more.

The composite electrolyte may include, for example, a carbonate-based solvent.

The carbonate-based solvent may include, for example, a cyclic carbonate-based solvent, a linear carbonate-based solvent, or a combination thereof.

The carbonate-based solvent may include, for example, a cyclic carbonate-based solvent. The cyclic carbonate-based solvent may include, for example, a cyclic fluorine-containing carbonate-based solvent, a cyclic fluorine-free carbonate-based solvent, or a combination thereof.

The cyclic carbonate-based solvent may include, for example, a compound represented by Formula 2:

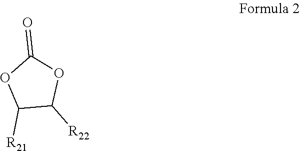

wherein, in Formula 2,
R₂₁ and R₂₂ may each independently be hydrogen, a halogen, or a C1-C10 alkyl group unsubstituted or substituted with a halogen. The halogen in the compound of Formula 2 may be, for example, fluorine (F).

The cyclic carbonate-based solvent may include, for example, ethylene carbonate (EC), propylene carbonate (PC), fluoroethylene carbonate (FEC), 4,4-difluoroethylenecarbonate, 4,5-difluoroethylenecarbonate, 4-methyl-5-fluoroethylene carbonate, 4-methyl-5,5-difluoroethylene carbonate, 4-(fluoromethyl)ethylene carbonate, 4-(difluoromethyl)ethylene carbonate, 4-(trifluoromethyl)ethylene carbonate, 4-(2-fluoroethyl)ethylene carbonate, 4-(2,2-difluoroethyl)ethylene carbonate, 4-(2,2,2-trifluoroethyl)ethylene carbonate, 4,5-dimethylethylenecarbonate, or a combination thereof.

The carbonate-based solvent may include, for example, a linear carbonate-based solvent. The linear carbonate-based solvent may include, for example, a linear fluorine-containing carbonate-based solvent, a linear fluorine-free carbonate-based solvent, or a combination thereof.

The linear carbonate-based solvent may include, for example, a compound represented by Formula 3:

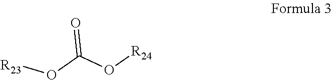

wherein, in Formula 3,
R₂₃ and R₂₄ may each independently be hydrogen, a halogen, or a C1-C10 alkyl group unsubstituted or substituted with a halogen. The halogen in the compound of Formula 3 may be, for example, F.

The linear carbonate-based solvent may include, for example, dimethylcarbonate, diethylcarbonate, methylethylcarbonate, methylpropylcarbonate, ethylpropylcarbonate, methylisopropylcarbonate, dipropylcarbonate, dibutylcarbonate, or a combination thereof.

### [Lithium Battery]

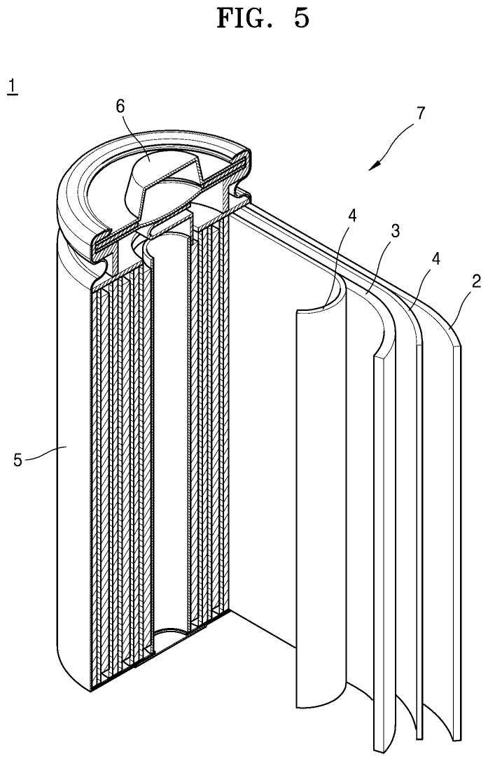

FIGS. 5 to 8 are each a schematic view of a lithium battery according to an embodiment.

Referring to FIGS. 5 to 8, a lithium battery 1 according to an embodiment includes: a cathode 3; an anode 2; and a composite separator 4 or a composite electrolyte 4 arranged between the cathode 3 and the anode 2. When the lithium battery 1 includes the composite separator 4 or a composite electrolyte 4, the heat resistance, flame retardancy, and lifespan characteristics of the lithium battery 1 may be improved.

### (Composite Separator or Composite Electrolyte)

Descriptions of the composite separator 4 and the composite electrolyte 4 are referred herein.

### (Anode)

The lithium battery 1 includes the anode 2, and the anode 2 may include: an anode current collector; and an anode active material layer arranged on one surface of the anode current collector.

The anode 2 may be, for example, prepared according to the following method, but the preparation method is not necessarily limited thereto and may be adjusted to required conditions.

First, an anode active material composition may be prepared by mixing an anode active material, a conductive material, a binder, and a solvent, and then the anode current collector may be directly coated with the anode active material composition and dried to prepare an anode electrode plate. Alternatively, an anode active material film obtained by casting the anode active material composition on a separate support and separating it from the support may be laminated on a copper current collector to prepare an anode electrode plate.

As the anode active material, any suitable anode active material available in the art for a lithium battery may be used. For example, the anode active material may include at least one of a lithium metal, a metal alloyable with lithium, a lithium alloy, a transition metal oxide, a non-transition metal oxide, and a carbon-based material.

The lithium alloy may include, for example, a Li—Al alloy, a Li—Sn alloy, a Li—In alloy, a Li—Ag alloy, a Li—Au alloy, a Li—Zn alloy, a Li—Ge alloy, a Li—Si alloy, or the like, but is not limited thereto. Any material alloyable with lithium in the art may be used. The anode active material layer may consist of lithium or one of the aforementioned alloys, or may be a lithium metal layer or a lithium-containing metal layer consisting of various types of alloys.

Examples of the metal alloyable with lithium are silicon (Si), tin (Sn), aluminum (Al), germanium (Ge), lead (Pb), bismuth (Bi), antimony (Sb), a Si—Y alloy (where Y is an alkali metal, an alkaline earth metal, a Group 13 element, a Group 14 element, a transition metal, a rare earth element, or a combination thereof, and Y is not Si), and a Sn—Y alloy (wherein Y is an alkali metal, an alkaline earth-metal, a Group 13 element, a Group 14 element, a transition metal, a rare earth element, or a combination thereof, and Y is not Sn). The element Y may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include, for example, a lithium titanium oxide, a vanadium oxide, a lithium vanadium oxide, and the like.

The non-transition metal oxide may be, for example, SnO₂, SiOx (where 0<x<2), and the like.

The carbon-based material may be, for example, crystalline carbon, amorphous carbon, or a mixture thereof. The crystalline carbon may be, for example, plate-like, flake-like, spherical, or fibrous graphite, such as natural graphite or artificial graphite. The amorphous carbon may be, for example, soft carbon (carbon sintered at a low temperature) or hard carbon, mesophase pitch carbide, sintered coke, and the like.

The contents of the anode active material, the conductive material, the binder, and the solvent may be at levels general for use in a lithium battery. Depending on the use and configuration of a lithium battery, one or more of the conductive material, the binder, and the solvent may be omitted.

A thickness of the anode active material layer may be, for example, in a range of about 1 μm to about 200 μm, about 1 μm to about 150 μm, about 1 μm to about 100 μm, about 1 μm to about 50 μm, about 1 μm to about 30 μm, about 1 μm to about 22 μm, or about 1 μm to about 10 μm, but is not limited thereto.

The anode current collector may include, for example, a metal substrate. The metal substrate may include, for example, copper (Cu), nickel (Ni), stainless steel (SUS), iron (Fe), cobalt (Co), and the like. The metal substrate may be, for example, composed of one type of the aforementioned metals, or composed of an alloy of two or more types of metals. The metal substrate may be, for example, in a sheet form or a foil form. A thickness of the anode current collector may be, for example, in a range of about 5 μm to about 50 μm, about 10 μm to about 50 μm, about 10 μm to about 40 μm, or about 10 μm to about 30 μm, but is not limited thereto.

The anode may include, for example, a lithium metal, a lithium alloy, or a combination thereof. When the anode includes a lithium metal, a lithium alloy, or a combination thereof, the energy of the lithium battery may be improved.

The ion-conductive composite film included in the composite separator or composite electrolyte may be, for example, arranged adjacent to the anode. When the ion-conductive composite film included in the composite separator or composite electrolyte is arranged adjacent to the anode, for example, to a lithium metal, the formation of dendrites in the lithium metal during a charging and discharging process of the lithium battery may be effectively suppressed. Consequently, the charge/discharge characteristics of the lithium battery may be further improved.

### (Cathode)

The lithium battery 1 includes the cathode 3, and the cathode 3 may include: a cathode current collector; and a cathode active material layer arranged on one surface of the cathode current collector.

The cathode 3 may be, for example, prepared according to the following method, but the preparation method is not necessarily limited thereto and may be adjusted to required conditions.

First, a cathode active material composition may be prepared by mixing a cathode active material, a conductive material, a binder, and a solvent. The prepared cathode active material composition may be directly applied onto an aluminum current collector and dried to prepare a cathode plate having a cathode active material layer formed thereon. Alternatively, the cathode active material composition may be cast on a separate support, and then a film obtained by peeling off from the support may be laminated onto the aluminum current collector to prepare a cathode plate having a cathode active material layer formed thereon.

Examples of the conductive material are: carbon black, graphite particulates, natural graphite, artificial graphite, acetylene black, Ketjen black, carbon fibers; carbon nanotubes; metallic powder, metallic fiber, or metallic tube of copper, nickel, aluminum, silver, and the like; and a conductive polymer such as a polyphenylene derivative. However, embodiments are not limited thereto, and any suitable conductive material available in the art may be used.

Examples of the binder are a vinylidene fluoride/hexafluoropropylene copolymer, polyvinylidene fluoride, polyacrylonitrile, polymethyl methacrylate, PTFE, a mixture of the aforementioned polymers, a styrene butadiene-rubber polymer, and the like, and examples of the solvent are N-methyl pyrrolidone (NMP), acetone, water, and the like. However, embodiments are not limited thereto, and any suitable binder and solvent available in the art may be used.

A plasticizer or a pore-forming agent may be added to the cathode active material composition to form pores in an electrode plate.

Amounts of the cathode active material, the conductive material, the binder, and the solvent used in the cathode may be at levels general for use in a lithium battery. Depending on the use and configuration of a lithium battery, one or more of the conductive material, the binder, and the solvent may be omitted.

The cathode active material layer may include a cathode active material. The cathode active material may use, for example, any material available as a lithium-containing metal oxide in the art may be used. The cathode active material may use, for example, at least one composite oxide of lithium and a metal selected from Co, Mn, Ni, and a combination thereof, and a specific example of the composite oxide is a compound represented by one of the following formulae: LiₐA_{1-b}B_{b}′D₂ (0.90≤a≤1 and 0≤b≤0.5); LiₐE_{1-b}B′_{b}O_{2-c}D_{c} (0.90≤a≤1, 0≤b≤0.5, and 0≤c≤0.05); LiE_{2-b}B′_{b}O_{4-c}D_{c} (0≤b≤0.5 and 0≤c≤0.05); LiₐNi_{1-b-c}CO_{b}B′_{c}Dₐ (0.90≤a≤1, 0≤b≤0.5, 0≤c≤0.05, and 0<a≤2); LiₐNi_{1-b-c}CO_{b}B′CO₂₋ₐFₐ (0.90<a≤1, 0<b>0.5, 0<c<0.05, and 0<<<2); LiₐNi_{1-b-c}Mn_{b}B′_{c}Dₐ (0.90≤a≤1, 0≤b≤0.5, 0≤c≤0.05, and 0<a≤2); LiₐNi_{1-b-c}Mn_{b}B′CO₂₋ₐF′ₐ (0.90≤a≤1, 0≤b≤0.5, 0≤c≤0.05, and 0<a<2); LiₐNi_{1-b-c}Mn_{b}B′CO₂₋ₐF′ₐ (0.90≤a≤1, 0≤b≤0.5, 0≤c≤0.05, and 0<a<2); LiₐNi_{b}E_{c}G_{d}O₂ (0.90≤a≤1, 0≤b≤0.9, 0≤c≤0.5, and 0.001≤d≤0.1); LiₐNi_{b}CO_{c}Mn_{d}GₑO₂ (0.90≤a≤1, 0≤b≤0.9, 0≤c≤0.5, 0≤d≤0.5, and 0.001≤e≤0.1); LiₐNiG_{b}O₂ (0.90≤a≤1 and 0.001≤b≤0.1); LiₐCoG_{b}O₂ (0.90≤a≤1 and 0.001≤b≤0.1); LiₐMnG_{b}O₂ (0.90≤a≤1 and 0.001≤b≤0.1); LiₐMn₂G_{b}O₄ (0.90≤a≤1 and 0.001≤b≤0.1); QO₂; QS₂; LiQS₂; V₂O₅; LiV₂O₅; Lil′O₂; LiNiVO₄; Li_{(3-f)}J₂(PO₄)₃ (where 0≤f≤2); Li_{(3-f)}Fe₂(PO₄)₃ (where 0≤f≤2); and LiFePO₄.

In the formulae above representing the compound, A may be Ni, Co, Mn, or a combination thereof; B′ may be Al, Ni, Co, Mn, Cr, Fe, Mg, Sr, V, a rare earth element, or a combination thereof; D may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. A compound in which a coating layer is additionally provided on the surface of the aforementioned compound may be also used, and a mixture of the aforementioned compound and a compound additionally provided with a coating layer may be also used. The coating layer provided on the surface of the compound may include, for example, a coating element compound, such as an oxide of a coating element, hydroxide of a coating element, oxyhydroxide of a coating element, oxycarbonate of a coating element, or hydroxycarbonate of a coating element. The compound constituting the coating layer may be amorphous or crystalline. The coating element included in the coating layer may be Mg, Al, Co, K, Na, Ca, Si, Ti, V, Sn, Ge, Ga, B, As, Zr, or a mixture thereof. A method of forming the coating layer may be selected within a range that does not adversely affect the physical properties of the cathode active material. The coating method may be, for example, spray coating, dipping method, or the like. A detailed description of the coating method will be omitted because it may be well understood by those skilled in the art.

The cathode active material may include, for example, a lithium transition metal oxide represented by one of Formulae 4 to 11:

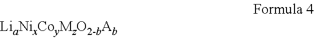

wherein, in Formula 4,
1.0≤a≤1.2, 0≤b≤0.2, 0.8≤x<1, 0≤y≤0.3, 0<z≤0.3, and x+y+z=1,
M may be manganese (Mn), cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), or a combination thereof, and
A may be fluorine (F), sulfur(S), chloride (Cl), bromide (Br), or a combination thereof,

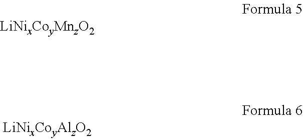

wherein, in Formulae 5 and 6, 0.8≤x≤0.95, 0≤y≤0.2, 0<z≤0.2, and x+y+z=1,

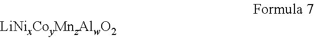

wherein, in Formula 7, 0.8≤x≤0.95, 0≤y≤0.2, 0<z≤0.2, 0<w≤0.2, and x+y+z+w=1,

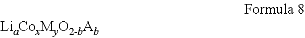

wherein, in Formula 8,
1.0≤a≤1.2, 0≤b≤0.2, 0.9≤x≤1, 0≤y≤0.1, and x+y=1,
M may be manganese (Mn), cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), or a combination thereof, and
A may be fluorine (F), sulfur(S), chloride (Cl), bromide (Br), or a combination thereof,

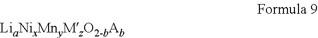

wherein, in Formula 9,
1.0≤a≤1.2, 0≤b≤0.2, 0<x≤0.3, 0.5≤y<1, 0<z≤0.3, and x+y+z=1,

M′ may be cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A may be fluorine (F), sulfur(S), chloride (Cl), bromide (Br), or a combination thereof,

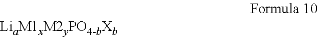

wherein, in Formula 10, 0.90≤a≤1.1, 0≤x≤0.9, 0≤y≤0.5, 0.9<x+y<1.1, and 0≤b≤2,
M1 may be chromium (Cr), manganese (Mn), iron (Fe), cobalt (Co), nickel (Ni), copper (Cu), zirconium (Zr), or a combination thereof, and
M2 may be Mg, Ca, Sr, Ba, Ti, Zn, B, Nb, Ga, In, Mo, W, Al, Si, Cr, V, Sc, Y, or a combination thereof, and X may be O, F, S, P, or a combination thereof,

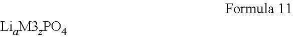

wherein, in Formula 11, 0.90≤a≤1.1, 0.9≤z≤1.1, and
M3 may be chromium (Cr), manganese (Mn), iron (Fe), cobalt (Co), nickel (Ni), copper (Cu), zirconium (Zr), or a combination thereof.

A thickness of the cathode active material layer may be, for example, in a range of about 1 μm to about 200 μm, about 1 μm to about 150 μm, about 1 μm to about 100 μm, about 1 μm to about 50 μm, about 1 μm to about 30 μm, about 1 μm to about 22 μm, or about 1 μm to about 10 μm, but is not limited thereto.

The cathode current collector may include, for example, a metal substrate. The metal substrate may consist of, for example, aluminum (Al), indium (In), copper (Cu), magnesium (Mg), stainless steel, titanium (Ti), iron (Fe), cobalt (Co), nickel (Ni), zinc (Zn), germanium (Ge), or an alloy thereof. The metal substrate may be, for example, composed of one type of the aforementioned metals, or composed of an alloy of two or more types of metals. The metal substrate may be, for example, in a sheet form or a foil form. A thickness of the cathode current collector may be, for example, in a range of about 5 μm to about 50 μm, about 10 μm to about 50 μm, about 10 μm to about 40 μm, or about 10 μm to about 30 μm, but is not limited thereto.

The lithium battery 1 may have, for example, the structure illustrated in FIGS. 5 to 8.

Referring to FIG. 5, the lithium battery 1 according to an embodiment includes the cathode 3, the anode 2, and the composite separator 4. The cathode 3, the anode 2, and the composite separator 4 may be wound or folded to form a battery structure 7. The formed battery structure 7 may be accommodated in a battery case 5. An electrolyte is injected into the battery case 5, and then cross-linked. Then, the battery case 5 is sealed with a cap assembly 6, thereby completing the manufacture of the lithium battery 1. The battery case 5 may be a cylindrical-type, but the shape of the battery case 5 is not limited thereto. For example, the battery case 5 may be a square-type, a thin-film type, or the like.

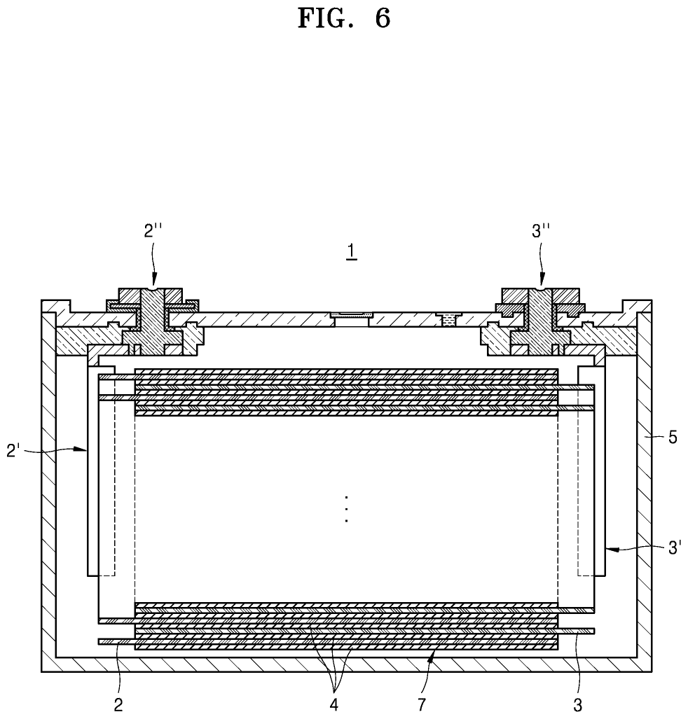

Referring to FIG. 6, the lithium battery 1 according to an embodiment includes the cathode 3, the anode 2, and the composite separator 4. The cathode 3, the anode 2, and the composite separator 4 may be wound, folded, or stacked to form a battery structure 7. The formed battery structure 7 may be accommodated in a battery case 5. An electrolyte is injected into the battery case 5, and then cross-linked. Then, the battery case 5 is sealed, thereby completing the manufacture of the lithium battery 1. The battery case 5 may be a square-type, but the shape of the battery case 5 is not limited thereto. For example, the battery case 5 may be a cylindrical-type, a thin-film type, or the like. The cathode 3 may be electrically connected to a cathode lead tab 3′ and a cathode terminal 3″. The anode 2 may be electrically connected to an anode lead tab 2′ and an anode terminal 2″.

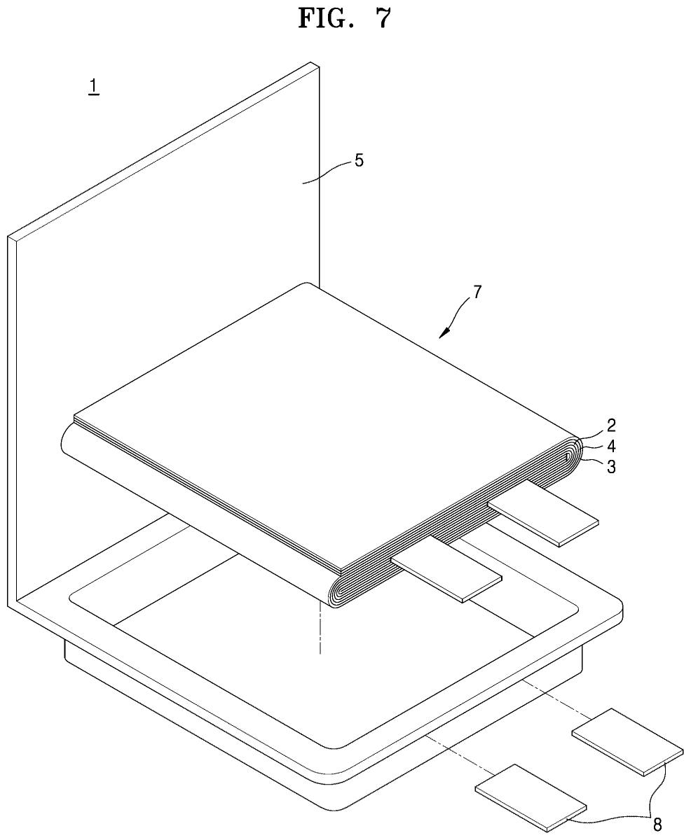

Referring to FIG. 7, the lithium battery 1 according to an embodiment includes the cathode 3, the anode 2, and the composite separator 4. The composite separator 4 may be arranged between the cathode 3 and the anode 2, and the cathode 3, the anode 2, and the composite separator 4 may be wound or folded to form a battery structure 7. The formed battery structure 7 may be accommodated in a battery case 5. The lithium secondary battery 1 may include electrode tabs 8 serving as an electrical path for inducing a current formed in the battery structure 7 to the outside. An electrolyte is injected into the battery case 5, and then cross-linked. Then, the battery case 5 is sealed, thereby completing the manufacture of the lithium battery 1. The battery case 5 may be a square-type, but the shape of the battery case 5 is not limited thereto. For example, the battery case 5 may be a cylindrical-type, a thin-film type, or the like.

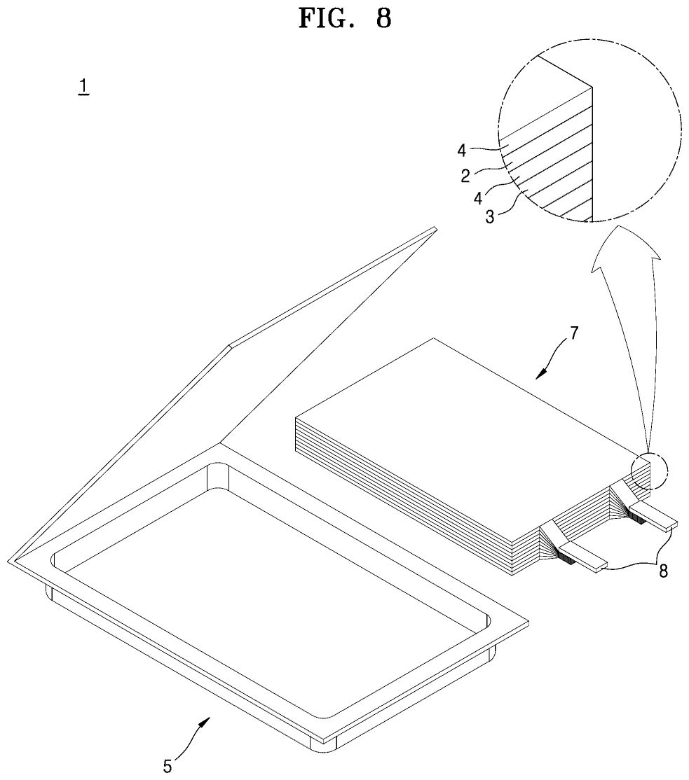

Referring to FIG. 8, the lithium battery 1 according to an embodiment includes the cathode 3, the anode 2, and the separator 4. The composite separator 4 may be arranged between the cathode 3 and the anode 2 to form the battery structure 7. The battery structure 7 may be laminated in a bi-cell structure, and then accommodated in the battery case 5. The lithium secondary battery 1 may include electrode tabs 8 serving as an electrical path for inducing a current formed in the battery structure 7 to the outside. An electrolyte is injected into the battery case 5, and then cross-linked. Then, the battery case 5 is sealed, thereby completing the manufacture of the lithium battery 1. The battery case 5 may be a square-type, but the shape of the battery case 5 is not limited thereto. For example, the battery case 5 may be a cylindrical-type, a thin-film type, or the like.

A pouch-type lithium battery uses a pouch as a case of the lithium battery shown in FIGS. 5 to 8. The pouch-type lithium battery may include at least one battery structure. The separator may be arranged between the cathode and the anode to form a battery structure. A plurality of battery structures may be stacked in the thickness direction, impregnated with an organic electrolyte solution, accommodated in a pouch, and then sealed to complete the manufacture of a pouch-type lithium metal battery. For example, although not shown in the drawings, the aforementioned cathode, anode, separator may be simply stacked and accommodated in a pouch in the form of an electrode assembly, or may be wound or folded into an electrode assembly in the form of a jelly roll to be then accommodated in a pouch. Then, an electrolyte is injected into the pouch, and the pouch is sealed to complete the manufacture of the lithium battery.

The lithium battery of the disclosure has excellent lifespan characteristics as well as high energy density, and thus may be, for example, used in an electric vehicle (EV). For example, the lithium metal battery may be used in a hybrid vehicle, such as a plug-in hybrid electric vehicle (PHEV) or the like. The lithium metal battery may also be applicable to the fields requiring high-power storage. For example, the lithium metal battery may be used in an electric bicycle, a power tool, or the like.

A plurality of the lithium batteries may be stacked to form a battery module, and a plurality of the battery modules may form a battery pack. The battery pack may be used in a device that requires high capacity and large output. For example, the battery pack may be used in a laptop computer, a smart phone, an electronic vehicle, or the like. The battery module may include, for example, multiple batteries and a frame that holds the multiple batteries. The battery pack may include, for example, multiple battery modules and a bus bar that connects the battery modules together. The battery module and/or the battery pack may further include a cooling device. The multiple battery packs may be managed by a battery management system. The battery management system may include a battery pack and an electronic control device connected to the battery pack.

Hereinafter, the present creative idea will be described in more detail through Examples and Comparative Examples below. However, these examples are provided to represent the creative idea, and the scope of the present creative idea is not limited thereto.

### (Preparation of Oxide-Based Solid Electrolyte)

### Preparation Examples 1 to 6: Preparation of Oxide-Based Solid Electrolyte

Al₂O₃ as an aluminum precursor, Ga₂O₃ as a gallium precursor, Ta₂O₅ as a tantalum precursor, Li₂CO₃ as a lithium precursor, La₂O₃ as a lanthanum precursor, and ZrO₂ as a zirconium precursor were mixed at a stoichiometric ratio, and then added to isopropyl alcohol (IPA). The mixture was milled using a planetary mill. To counteract volatilization of lithium in a calcination process, a lithium precursor, Li₂CO₃, was added at 10% or 20% in addition to the stoichiometric ratio. After drying the solution resulting from ball milling, the resulting product was calcined for 6 hours at 1000° C. or 1250° C. to prepare a LLZO oxide-based solid electrolyte. The temperature for the preparation, the added Li₂CO₃ content, and the composition of the oxide-based solid electrolyte are shown in Table 1. The composition of the oxide-based solid electrolyte was determined by inductively coupled plasma atomic emission spectroscopy (ICP-AES).

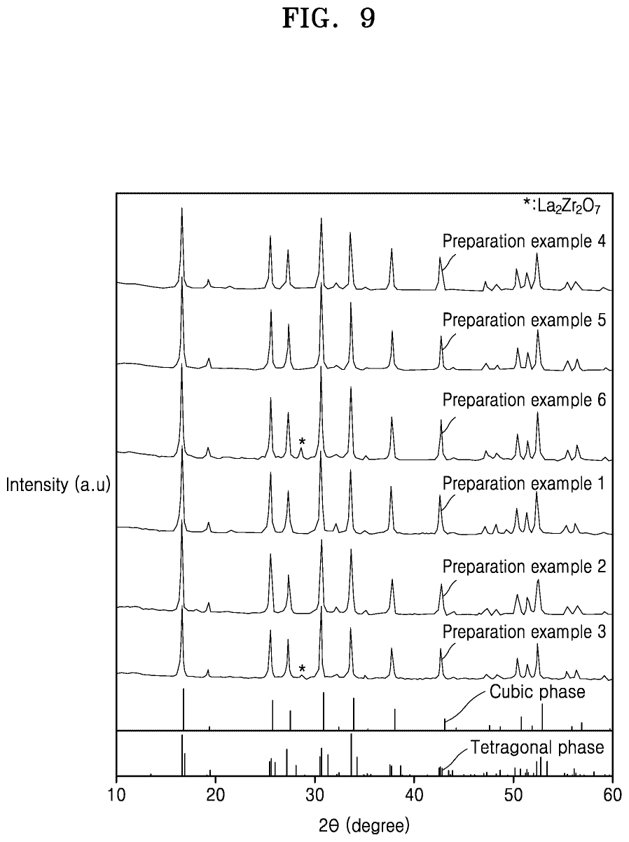

For the oxide-based solid electrolytes prepared in Preparation Examples 1 to 6, XRD spectra were measured, and the results thereof are shown in FIG. 9.

As shown in FIG. 9, the oxide-based solid electrolytes prepared in Preparation Examples 1 to 6 mainly included a cubic phase while barely including a tetragonal phase.

TABLE 1

| | Calcination | |
|---|---|---|
| | temperature and | |
| | added Li₂CO₃ | |
| | content | Composition of solid electrolyte |
| Preparation | 1000° C. / 20% | Li_{7.59}La₃Zr_{1.87}Ga_{0.06}Ta_{0.01}Al_{0.18}O₁₂ |
| Example 1 | | |
| Preparation | 1000° C. / 10% | Li_{6.88}La₃Zr_{1.84}Ga_{0.06}Ta_{0.01}A_{l0.17}O₁₂ |
| Example 2 | | |
| Preparation | 1000° C. / 0% | Li_{6.18}La₃Zr_{1.85}Ga_{0.06}Ta_{0.02}Al_{0.19}O₁₂ |
| Example 3 | | |
| Preparation | 1250° C. / 20% | Li_{7.09}La₃Zr_{1.90}Ga_{0.06}Ta_{0.01}Al_{0.18}O₁₂ |
| Example 4 | | |
| Preparation | 1250° C. / 10% | Li_{6.58}La₃Zr_{1.92}Ga_{0.06}Ta_{0.01}Al_{0.19}O₁₂ |
| Example 5 | | |
| Preparation | 1250° C. / 0% | Li_{6.07}La₃Zr_{1.86}Ga_{0.06}Ta_{0.01}Al_{0.19}O₁₂ |
| Example 6 | | |

### (Preparation of Ion-Conductive Composite Film)

### Preparation Example 7: Preparation of Ion-Conductive Composite Film (Li_{7.59} LLZO+EVA), LLZO 90 wt %

The solid electrolyte powder prepared in Preparation Example 1 and ethylene-vinyl acetate (EVA) were added at a weight ratio of 90:10 in a chlorobenzene solvent, and the mixture was stirred to prepare a mixed solution. The mixed solution was added into a planetary mill and milled to prepare a milled mixed solution. The milled mixed solution was tape-cast onto a glass substrate using a doctor blade, the solvent was removed therefrom, and then an ion-conductive composite film was separated from the glass substrate. The ion-conductive composite film was a free-standing film.

### Preparation Example 8: Preparation of Ion-Conductive Composite Film (Li_{6.07} LLZO+EVA), LLZO 90 wt %

An ion-conductive composite film was prepared by the same method used in Preparation Example 7, except that the solid electrolyte powder prepared in Preparation Example 6 was used instead of the solid electrolyte powder prepared in Preparation Example 1.

### Comparative Preparation Example 1: Preparation of Ion-Conductive Composite Film (Li_{7.59} LLZO+EVA), LLZO 50 wt %

An ion-conductive composite film was prepared by the same method used in Preparation Example 7, except that the weight ratio of the solid electrolyte powder prepared in Preparation Example 1 and the EVA was changed to 50:50.

### (Preparation of Porous Substrate)

### Preparation Example 9: Porous Substrate Including Aligned Polymer Fibers (Aligned PAN)

Polyacrylonitrile (PAN) with a number-average molecular weight of 150,000 dalton was dissolved in a dimethylformamide (DMF) solvent and stirred at 50° C. to prepare a 10 wt % polymer solution.

The polymer solution was cooled at room temperature, and then was subjected to electrospinning. Here, the spinning voltage was 15 kV, the spinning distance was 12 cm, and the supply rate of spinning solution was 1.5 mL/h.

The electrospun PAN fibers were collected using a rotating drum at a rotational speed of 2800 rpm. After completion of the electrospinning, a porous nonwoven web was separated from the rotating drum to prepare a first porous substrate. The porous nonwoven web as the first porous substrate included a plurality of PAN fibers aligned in a first direction.

FIG. 10A shows a scanning electron microscope image of the surface of the prepared first porous substrate. As shown in FIG. 10A, it was confirmed that a plurality of PAN fibers were aligned in the first direction.

Here, an average diameter of the PAN fibers was about 255 nm. The average diameter of the PAN fibers refers to an arithmetic mean value calculated from the diameters of 30 fibers measured using a software (Fiji) from the scanning electron microscope image of the surface of the first porous substrate.

### Comparative Preparation Example 2: Porous Substrate Including Non-Aligned Polymer Fibers (Non-Aligned PAN)

A porous substrate was prepared in the same manner as in Preparation Example 9, except that the electrospun PAN fibers were collected using a rotating drum at a rotational speed of 200 rpm.

The prepared porous substrate included non-aligned polymer fibers.

FIG. 10B shows a scanning electron microscope image of the surface of the prepared porous substrate. As shown in FIG. 10B, it was confirmed that a plurality of PAN fibers were arranged in a non-aligned and non-directional manner.

### (Preparation of Composite Separator)

### Example 1: First Porous Substrate (PAN Fibers, 50 μm-Thick)/Ion-Conductive Composite Film (Li_{7.59} LLZO+EVA, 20 Jum-Thick), LLZO 90 wt %

The ion-conductive composite film prepared in Preparation Example 7 was arranged on one surface of the first porous substrate prepared in Preparation Example 9, followed by hot pressing, to prepare a composite separator.

Here, the thickness of the composite separator was about 70 μm, the thickness of the first porous substrate was about 50 μm, and the thickness of the ion-conductive composite film was about 20 μm.

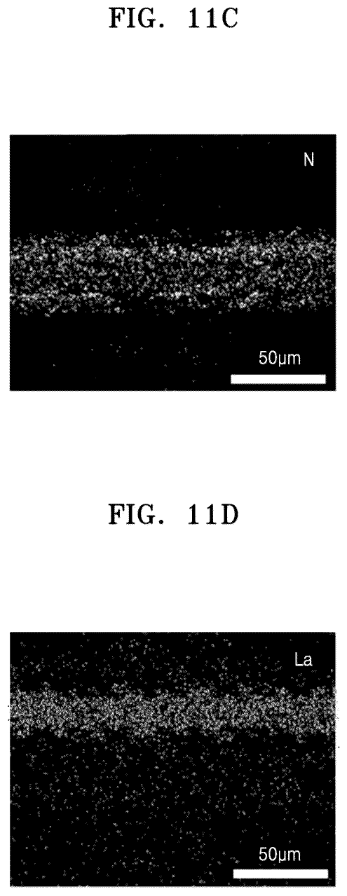

FIGS. 11A to 11D show scanning electron microscope (SEM) and energy dispersive spectroscope (EDS) analysis images for the cross-section of the prepared composite separator.

Referring to FIGS. 11A to 11D, the first porous substrate including PAN fibers including carbon and nitrogen was arranged at the bottom of the composite separator, whereas the ion-conductive composite film including LLZO was arranged at the top of the composite separator.

### Example 2: First Porous Substrate (PAN Fibers, 50 μm-Thick)/Ion-Conductive Composite Film (Li_{6.07} LLZO+EVA, 20 μm-Thick), LLZO 90 wt %

The ion-conductive composite film prepared in Preparation Example 8 was arranged on one surface of the first porous substrate prepared in Preparation Example 9, followed by hot pressing, to prepare a composite separator.

Here, the thickness of the composite separator was about 70 μm, the thickness of the first porous substrate was about 50 μm, and the thickness of the ion-conductive composite film was about 20 μm.

### Comparative Example 1: Non-Fiber Separator

The commercially available separator (Celgard 2400) was used as supplied.

### Comparative Example 2: First Porous Substrate (PAN Fibers, 50 μm-Thick)/Ion-Conductive Composite Film (Li_{7.59} LLZO+EVA, 20 μm-Thick), LLZO 50 wt %

A composite separator was prepared by the same method used in Example 1, except that the ion-conductive composite film prepared in Comparative Preparation Example 1 was arranged on one surface of the first porous substrate prepared in Preparation Example 9.

### Evaluation Example 1: Morphology Measurement

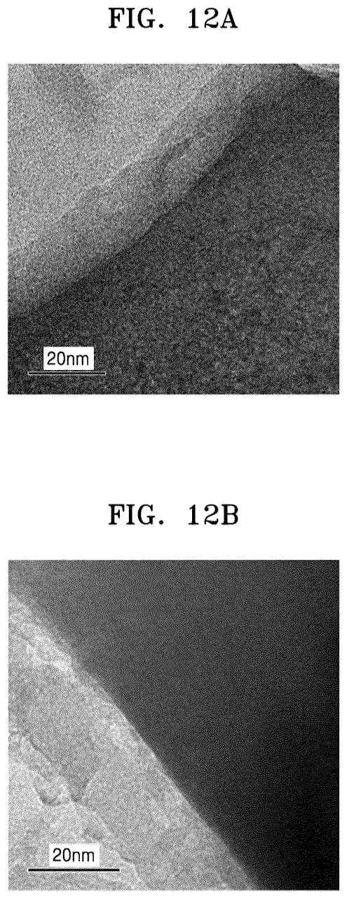

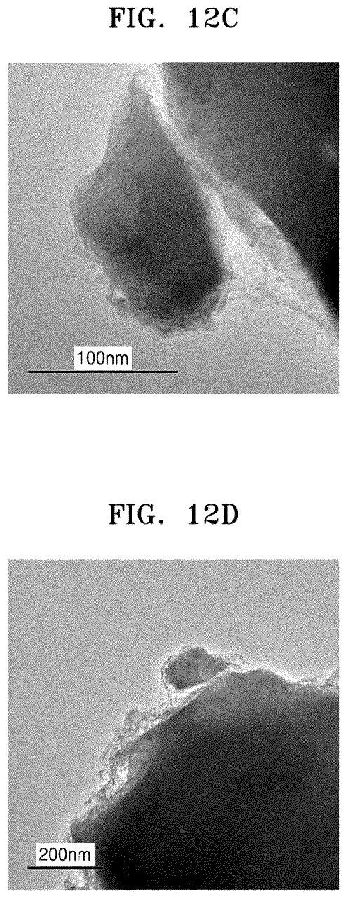

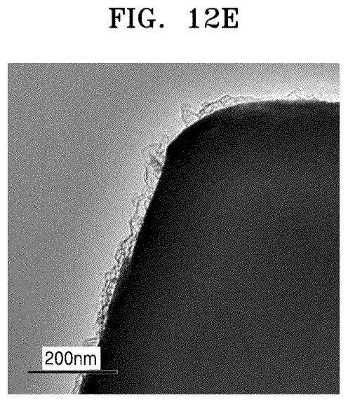

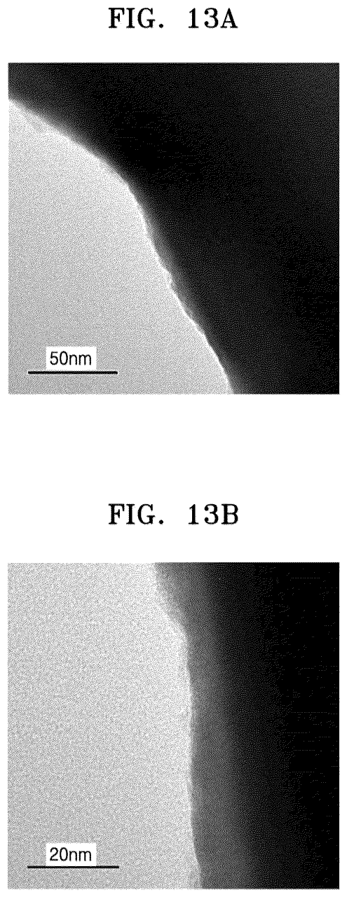

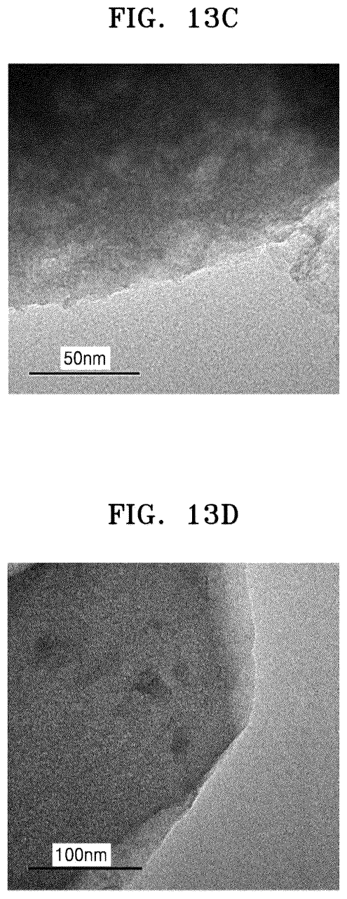

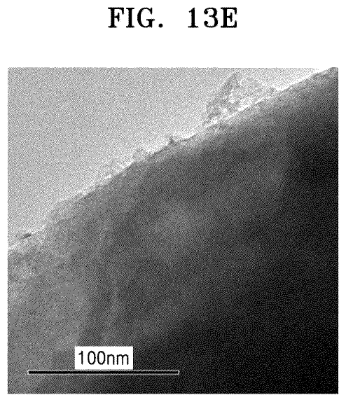

For the Ga-, Ta-, and Al-doped LLZO solid electrolyte particles prepared in Preparation Examples 1 and 6, the surface morphology was measured using a scanning electron microscope. The measurement results are shown in FIGS. 12A to 12E and FIGS. 13A to 13E.

FIGS. 12A to 12E are scanning electron microscope images of the LLZO solid electrolyte particles prepared in Preparation Example 1.

FIGS. 13A to 13E are scanning electron microscope images of the LLZO solid electrolyte particles prepared in Preparation Example 6.

As shown in FIGS. 12A to 12E, it was confirmed that the LLZO solid electrolyte particles with high lithium content prepared in Preparation Example 1 included a conformal coating layer that is arranged along the surface contour of the solid electrolyte particles. Here, a thickness of the conformal coating layer was about 20 to about 30 nm. By measuring infrared spectroscopy (IR) spectra for the solid electrolyte particles, it was confirmed that the conformal coating layer included a lithium-containing compound such as Li₂CO₃ and LiOH.

As shown in FIGS. 13A to 13E, it was confirmed that the LLZO solid electrolyte particles with low lithium content prepared in Preparation Example 6 did not include a conformal coating layer that is arranged along the surface contour of the solid electrolyte particles. It was also confirmed that lithium-containing compounds remained in the island-like formation on portions of the surface of the LLZO solid electrolyte particles.

### Evaluation Example 2: XPS Depth Profile Measurement

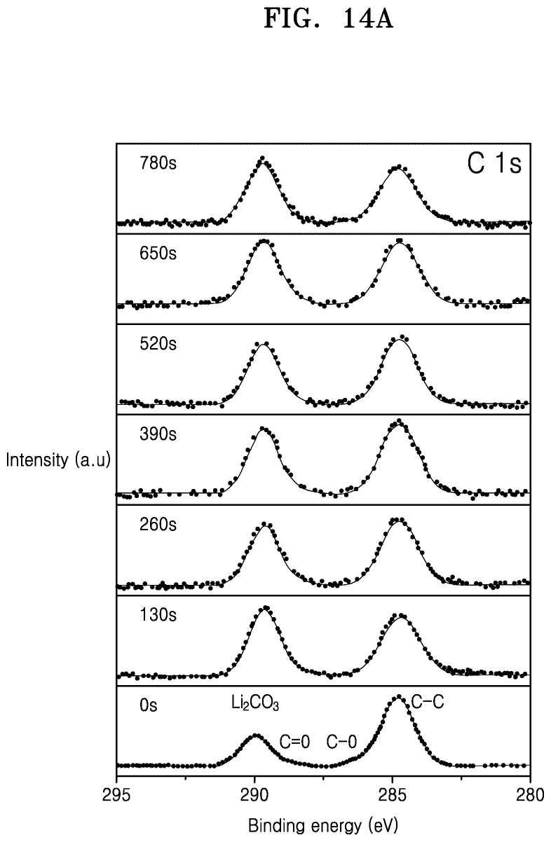

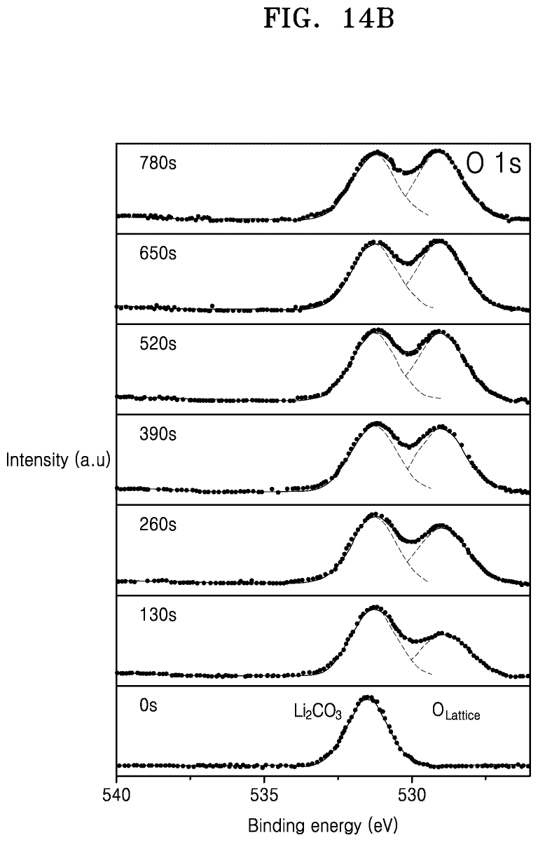

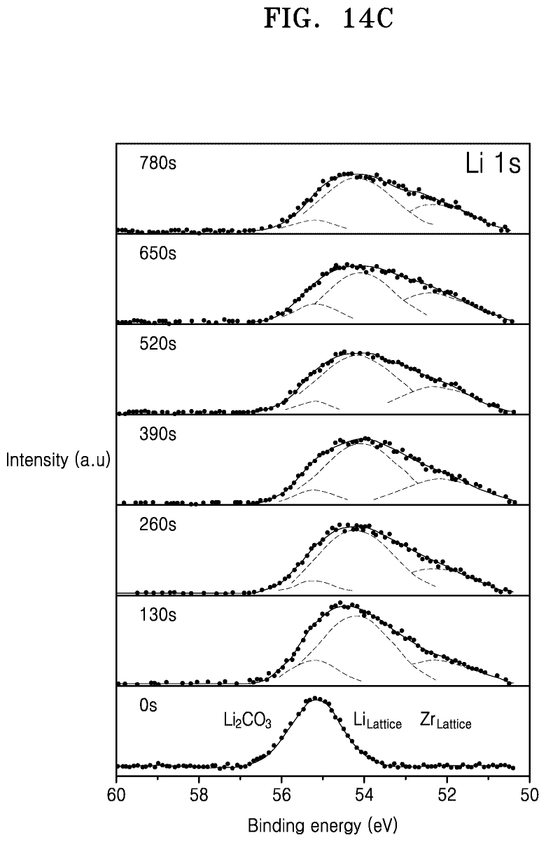

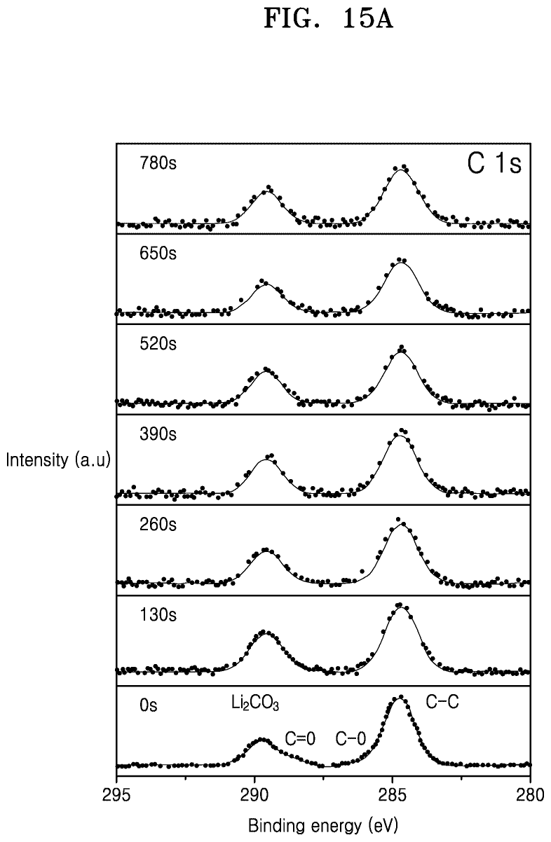

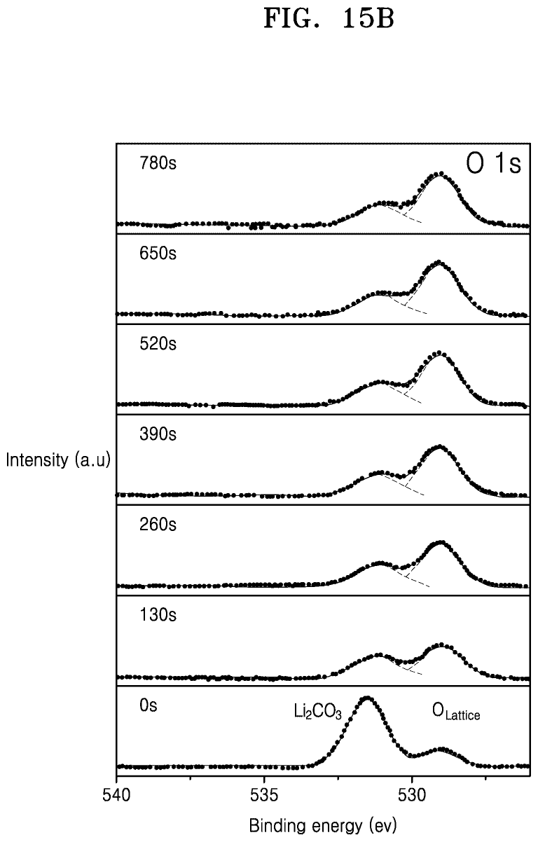

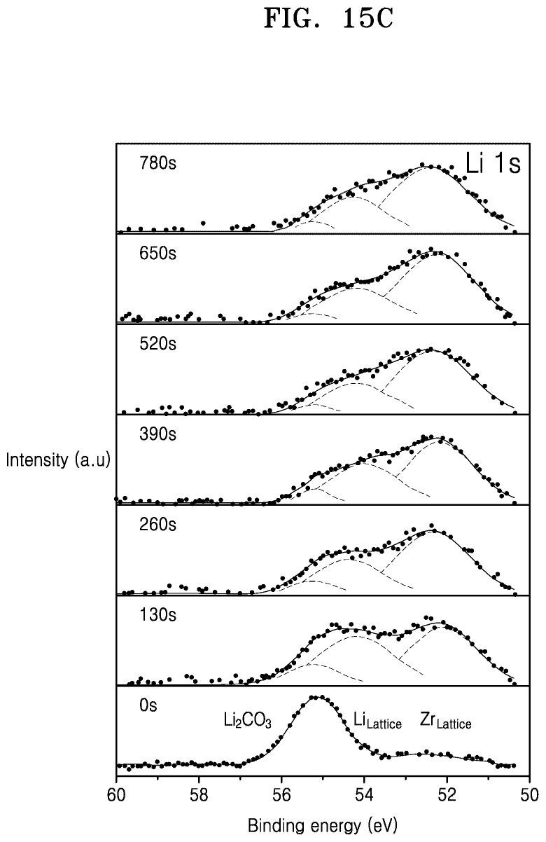

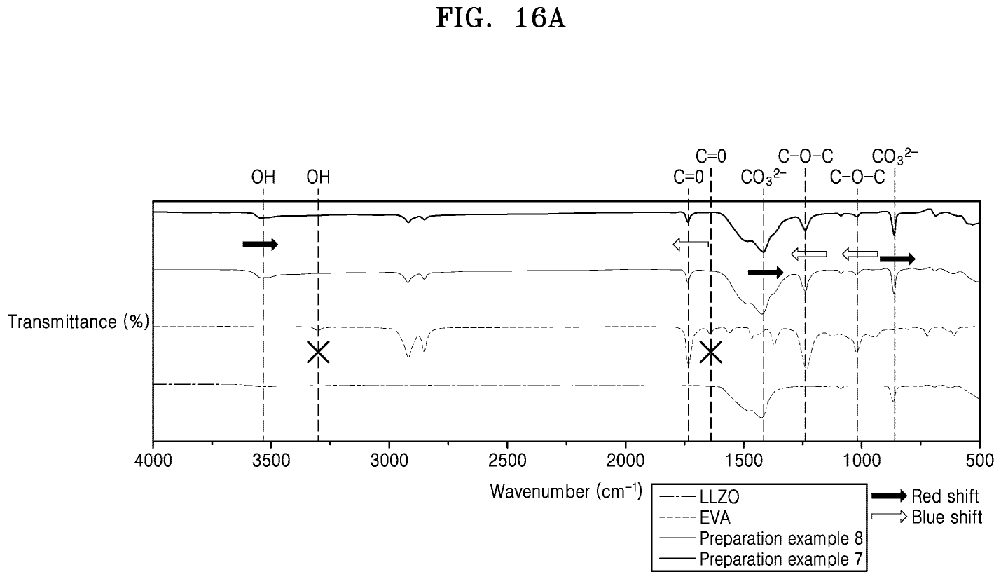

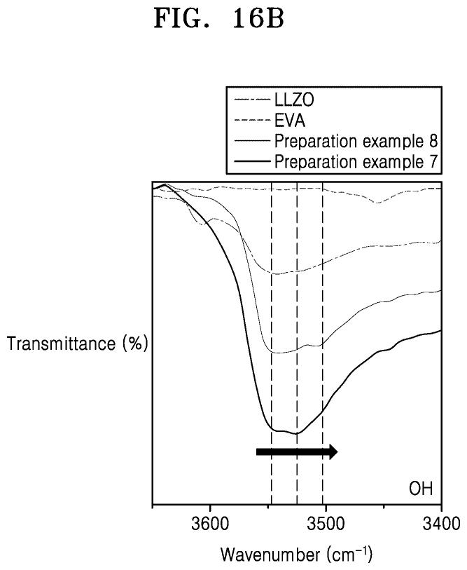

XPS depth profiles were measured by analyzing the composition according to the depth while etching the surface of the Ga-, Ta-, and Al-doped LLZO solid electrolyte particles prepared in Preparation Examples 1 and 6 by ion-sputtering. The measurement results are shown in FIGS. 14A to 14C and FIGS. 15A to 15C.

The ion-sputtering may be, for example, performed using Ar⁺ ion beams.

FIGS. 14A to 14C show the results of measuring XPS depth profiles on the surface of the LLZO solid electrolyte particles prepared in Preparation Example 1.

FIGS. 15A to 15C show the results of measuring XPS depth profiles on the surface of LLZO solid electrolyte particles prepared in Preparation Example 6.

FIGS. 14A and 15A are graphs showing the change in carbon peak intensity over etching time. Peaks on the left are derived from the C═O bond in Li₂CO₃.

FIGS. 14B and 15B are graphs showing the change in oxygen peak intensity over etching time. Peaks on the left are derived from oxygen in Li₂CO₃, and peaks on the right are derived from lattice oxygen (O_{lattice}) of the LLZO solid electrolyte.

FIGS. 14C and 15C are graphs showing the change in lithium peak intensity over etching time. Peaks on the left are derived from lithium in Li₂CO₃, peaks in the middle are derived from lattice lithium (Lilattice) in LLZO, and peaks on the right are derived from lattice zirconium (Zrlattice) in LLZO.

As shown in FIG. 14B, the LLZO solid electrolyte particles prepared in Preparation Example 1 were free of second oxygen peaks derived from the lattice oxygen (O_{lattice}) of the LLZO solid electrolyte appearing at 527.5 eV to 530 eV, at the start of sputtering (i.e., at 0 second). FIG. 14B confirmed that the coating layer including Li₂CO₃ was predominantly arranged on the surface of the LLZO solid electrolyte.

As shown in FIG. 14B, the LLZO solid electrolyte prepared in Preparation Example 1 exhibited a ratio (P2/P1) of the intensity of the second oxygen peak (P2) to the intensity of the first oxygen peak (P1) of 1 or less within the range of 130 seconds to 780 seconds from the start of sputtering, wherein the second oxygen peak is derived from the lattice oxygen (O_{lattice}) of the LLZO solid electrolyte appearing at 527.5 eV to 530 eV, and the first oxygen peak is derived from the lithium carbonate (Li₂CO₃) appearing at 530 eV to 532.5 eV. FIG. 14B confirmed that the coating layer including Li₂CO₃ present on the surface of the LLZO solid electrolyte has a large thickness.

Meanwhile, as shown in FIG. 15B, the LLZO solid electrolyte prepared in Preparation Example 6 exhibited second oxygen peaks derived from the lattice oxygen (O_{lattice}) of the LLZO solid electrolyte appearing at 527.5 eV to 530 eV, at the start of sputtering (i.e., at 0 second). FIG. 15B confirmed that LLZO with a cubic phase was exposed on the surface of the LLZO, in addition to the coating layer including Li₂CO₃.

As shown in FIG. 14B, the LLZO solid electrolyte particles prepared in Preparation Example 6 exhibited a ratio (P2/P1) of the intensity of the second oxygen peak (P2) to the intensity of the first oxygen peak (P1) of less than 1 after 130 seconds from the art of sputtering, wherein the second oxygen peak is derived from the lattice oxygen (O_{lattice}) of the LLZO solid electrolyte appearing at 527.5 eV to 530 eV, and the first oxygen peak is derived from Li₂CO₃ appearing at 530 eV to 532.5 eV. FIG. 15B confirmed that the coating layer including Li₂CO₃ present on the surface of the LLZO solid electrolyte has a very small thickness.

### Evaluation Example 3: Fourier-Transform Infrared Spectroscopy (FT-IR) Measurement

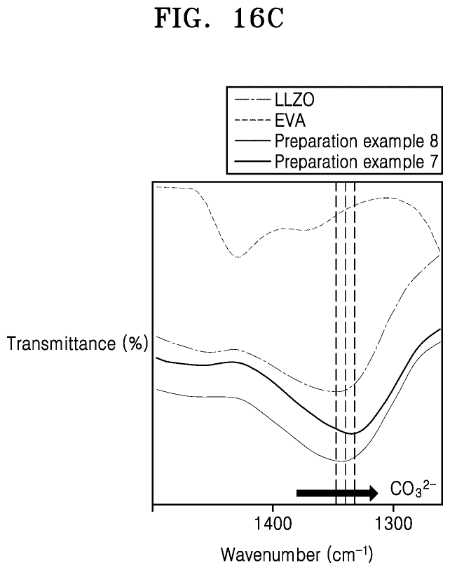

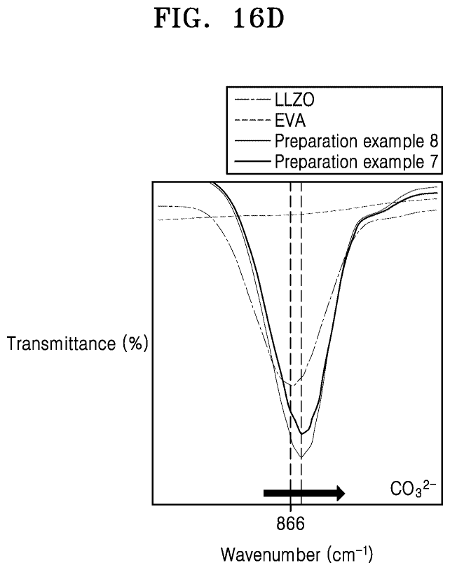

The solid electrolyte prepared in Preparation Example 1, the EVA polymer used in Preparation Example 7, and the ion-conductive composite films prepared in Preparation Examples 7 and 8 were each subjected to FT-IR measurement, and the results are shown in FIGS. 16A to 16D.

FIG. 16A shows FT-IR spectra of the solid electrolyte prepared in Preparation Example 1, the EVA polymer used in Preparation Example 7, and the ion-conductive composite films prepared in Preparation Examples 7 and 8.

FIGS. 16B to 16D are partial enlargements of FIG. 16A.

Referring to FIG. 16B, the OH peak in the ion-conductive composite films of Preparation Examples 7 and 8 exhibited a red shift, shifting to a lower wavenumber compared to the OH peak in the LLZO at 3550 cm 1. LiOH arranged on the LLZO solid electrolyte exhibited a red shift, characterized by a decrease in the intensity of the peak at 3550 cm 1 and an increase in the intensity of the peak at 3500 cm 1 derived from the OH bond, due to the formation of hydrogen bonds between LiOH and the carbonyl groups (C═O) and ether groups (C—O—C) of the EVA polymer.

Referring to FIGS. 16C and 16D, the CO₃²⁻ peak in the ion-conductive composite films of Preparation Examples 7 and 8 exhibited a red shift, shifting to a lower wavenumber compared to the CO₃²⁻ peak in the LLZO at 1423 cm 1 and 866 cm 1. Li₂CO₃ arranged on the LLZO solid electrolyte exhibited a red shift where the positions of the peaks at 1423 cm 1 and 866 cm⁻¹ derived from the CO₃²⁻ bond shifted to lower numbers, due to the formation of hydrogen bonds with the C—H groups of the EVA polymer.

Referring to 16A to 16D, it was confirmed that the ion-conductive composite film of Preparation Example 7 exhibited a greater red shift compared to the ion-conductive composite film of Preparation Example 8, due to the formation of stronger hydrogen bonds. The ion-conductive composite film of Preparation Example 7 including a thick conformal coating layer including LiOH or Li₂CO₃ was also confirmed to be strongly bonded to the EVA polymer via hydrogen bonds, compared to the ion-conductive composite film of Preparation Example 8.

### Evaluation Example 4: Tensile Strength Measurement

For the non-aligned porous substrate prepared in Comparative Preparation Example 2, the aligned porous substrate prepared in Preparation Example 9, and the composite separator prepared in Example 1, the tensile strength was measured.

The tensile strength was measured along the direction in which the polymer fibers included in the aligned porous substrate prepared in Preparation Example 9 were aligned. The tensile strength was measured using a universal test machine.

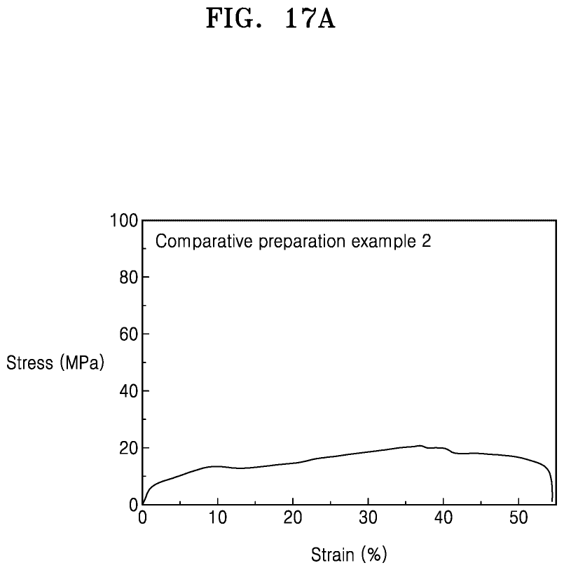

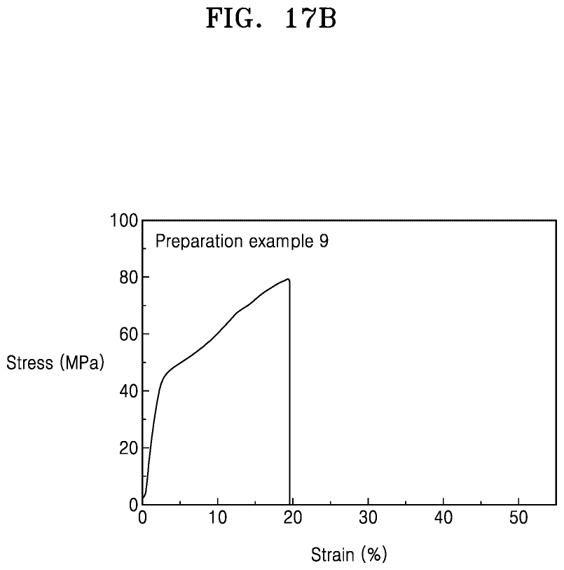

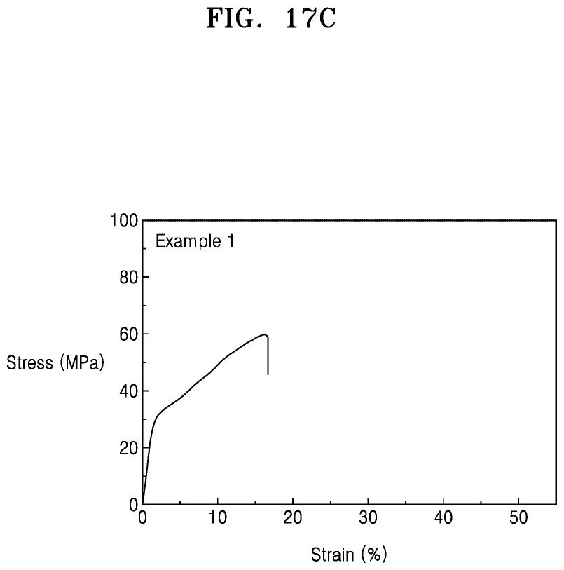

The maximum stress was measured as tensile strength from the stress-strain graph. The measurement results are shown in FIGS. 17A to 17C and Table 2.

TABLE 2

| | Tensile strength [MPa] |
|---|---|
| Comparative Preparation | 20.78 |
| Example 2 | |
| Preparation Example 9 | 79.63 |
| Example 1 | 59.79 |

As shown in Table 2, the composite separator of Example 1 exhibited the tensile strength about three times greater than that of the porous substrate of Comparative Preparation Example 2 including the non-aligned polymer fibers.

The porous substrate of Preparation Example 9 including the aligned polymer fibers exhibited the tensile strength about four times greater than that of the porous substrate of Comparative Preparation Example 2.

### Evaluation Example 5: Thermal Stability Evaluation

For the separator (Celgard) of Comparative Example 1, the porous substrate including the aligned polymer fibers (PAN) prepared in Preparation Example 9, and the composite separator prepared in Example 1 (PAN@LLZO), the thermal stability was evaluated.

The thermal stability was evaluated by measuring the thermal shrinkage ratio of a specimen.

The thermal shrinkage ratio was evaluated from the change in area after leaving 30 mm×30 mm square specimens in ovens at 25° C., 120° C., and 180° C. for 30 minutes each (after heat treatment).

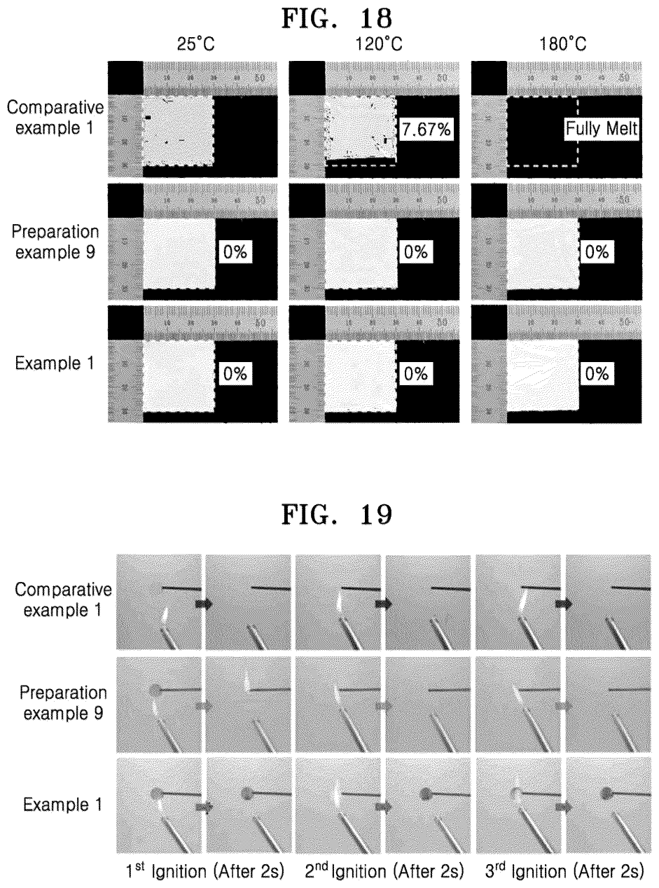

The thermal shrinkage ratio refers to the percentage ratio of the specimen area after heat treatment to the original specimen area. The evaluation results are shown in FIG. 18.

As shown in FIG. 18, the separator of Comparative Example 1 exhibited a thermal shrinkage ratio of 7.67% at 120° C., and was completely melted at 180° C.

Meanwhile, the porous substrate of Preparation Example 9 and the composite separator of Example 1 showed excellent thermal stability without thermal shrinkage.

### Evaluation Example 6: Flame Retardancy Evaluation

For the separator (Celgard) of Comparative Example 1, the porous substrate prepared in Preparation Example 9 including the aligned polymer fibers (PAN), and the composite separator prepared in Example 1 (PAN@LLZO), the flame retardancy was evaluated.

A circular specimen was brought into contact with the flame, and its shape was observed after 2 seconds. By repeating this process three times, the flame retardancy was evaluated. The evaluation results are shown in FIG. 19.

As shown in FIG. 19, the separator of Comparative Example 1 was completely melted upon the first flame contact.

The porous substrate of Preparation Example 9 ignited upon the first flame contact, and was completely consumed.

The composite separator of Example 1 showed excellent flame retardancy, maintaining its original form without ignition occurring even after the third flame contact.

### Evaluation Example 7: Ionic Conductivity Measurement

For the separator of Comparative Example 1 (Celgard), the composite separator prepared in Comparative Example 2, the ion-conductive composite film prepared in Preparation Example 7, the porous substrate including the aligned polymer fibers prepared in Preparation Example 9, and the composite separator prepared in Example 1, the impedance was measured. The separator of Comparative Example 1, the composite separator of Comparative Example 2, the ion-conductive composite film of Preparation Example 7, the porous substrate of Preparation Example 9, and the composite separator of Example 1 were each impregnated with a liquid electrolyte, placed between symmetrical cells of a stainless steel electrode, and then measured for impedance. For use as the liquid electrolyte, a liquid electrolyte in which 1.0 M LiPF₆ and vinylene carbonate (VC) 2 wt % were dissolved in a mixed solvent of EC/EMC at volume ratio of 3:7 was used. For the impedance measurement, the impedance was measured by a 2-probe method using an impedance analyzer (Solartron 1560A). Here, the frequency range was 0.1 Hz to 32 MHz, and the amplitude voltage was 30 mV. The measurement was performed at 25° C. in the air atmosphere. The electrolyte resistance was determined from the Nyquist plot of the impedance measurement results, and the conductivity was calculated therefrom. The results are shown in Table 3.

TABLE 3

| | Ionic conductivity [mS/cm] |
|---|---|
| Comparative Example 1 | 0.46 |
| Comparative Example 2 | 0.0027 |
| Preparation Example 7 | 0.47 |
| Preparation Example 9 | 2.01 |
| Example 1 | 0.85 |

As shown in Table 3, the ion-conductive composite film prepared in Preparation Example 7 exhibited equivalent or greater ionic conductivity compared to the commercially available separator of Comparative Example 1.

The composite separator prepared in Example 1 and the porous substrate including the aligned polymer fibers of Preparation Example 9 exhibited improved ionic conductivity compared to the commercially available separator of Comparative Example 1.

The composite separator prepared in Comparative Example 2 showed significantly reduced ionic conductivity compared to the composite separator prepared in Example 1.

### Evaluation Example 8: Electrochemical Stability (Linear Sweep Voltammetry, LSV) Evaluation

For the separator of Comparative Example 1 (Celgard), the ion-conductive composite film prepared in Preparation Example 7 (LLZO-EVA), the porous substrate including the aligned polymer fibers (PAN) prepared in Preparation Example 9, and the composite separator of Example 1 (PAN@LLZO), the electrochemical stability was evaluated by LSV.

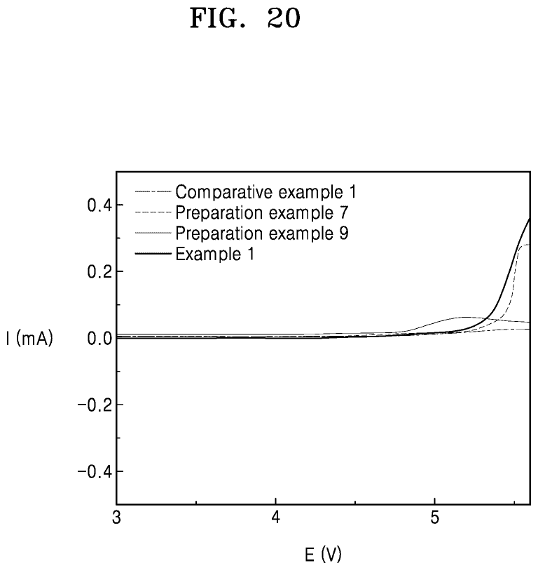

The separator of Comparative Example 1, the ion-conductive composite film of Preparation Example 7, the porous substrate of Preparation Example 9, and the composite separator of Example 1 were each impregnated with a liquid electrolyte and measured for the electrochemical stability. For use as the liquid electrolyte, a liquid electrolyte in which 1.0 M LiPF₆ and VC 2 wt % were dissolved in a mixed solvent of EC/EMC at volume ratio of 3:7 was used. The separator of Comparative Example 1 (Celgard), the ion-conductive composite film prepared in Preparation Example 7, the porous substrate including the aligned polymer fibers prepared in Preparation Example 9, and the composite separator of Example 1 were each placed between a lithium (Li) metal and a stainless steel electrode. Then, at a scanning rate of 1 mV/seC over the voltage range of 0 V to 6 V (vs. Li), the electrochemical stability was evaluated by measuring the current versus potential according to LSV. The evaluation results are shown in FIG. 20.

As shown in FIG. 20, the composite separator of Example 1 showed the onset potential of 5.0 V (vs. Li) or more. The composite separator of Example 1 had wide electrochemical stability voltage window of 5.0 V or more. Meanwhile, the porous substrate of Preparation Example 9 showed the onset potential of less than 4.6 V.

### Evaluation Example 9: Heat Resistance Evaluation of First Polymer

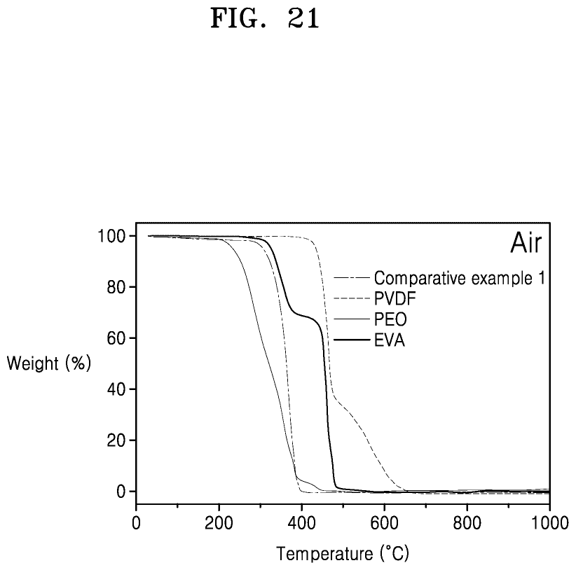

For the separator of Comparative Example 1 (Celgard), PVDF, PEO, and the EVA used in Preparation Example 7, the thermal decomposition temperature was measured by TGA. The measurement results are shown in FIG. 21.

As shown in FIG. 21, the thermal decomposition temperatures of the separator of Comparative Example 1 (Celgard), PVDF, and the EVA used in Preparation Example 7 were 350° C. or more. Meanwhile, the thermal decomposition temperature of PEO was less than 350° C.

### (Preparation of Lithium Battery)

### Example 3

### (Preparation of Cathode)

LiNi_{0.8}Co_{0.1}Mn_{0.1}O₂ was included as a cathode active material, and a commercially available cathode including the cathode active material, a conductive material, and a binder at a weight ratio of 90:5:5 was used.

### (Preparation of Lithium Battery)

A lithium metal chip was used as an anode.

The composite separator prepared in Example 1 was arranged between the cathode and the anode to prepare a laminate. The ion-conductive composite film of the composite separator was arranged adjacent to the anode.

The prepared laminate was filled with a liquid electrolyte and sealed to prepare a half cell. For use as the liquid electrolyte, a liquid electrolyte in which 1.0 M LiPF₆ and VC 2 wt % were dissolved in a mixed solvent of EC/EMC at volume ratio of 3:7 was used.

### Comparative Example 3

A lithium battery was prepared by the same method used in Example 3, except that the porous substrate including the aligned polymer fibers prepared in Preparation Example 9 was used instead of the composite separator prepared in Example 1. Comparative Example 4

A lithium battery was prepared by the same method used in Example 3, except that the composite separator prepared in Comparative Example 2 was used instead of the composite separator prepared in Example 1.

Evaluation Example 10: Charge/discharge test

For the lithium batteries of Example 3 and Comparative Examples 3 and 4, the charging and discharging test was conducted at room temperature (25° C.) under the following conditions.

The lithium batteries were each charged at a constant current of 0.1 C rate until the voltage reached 4.3 V (vs. Li). Subsequently, the lithium batteries were each discharged at a constant current of 0.1 C rate until the voltage reached 2.7 V (vs. Li).

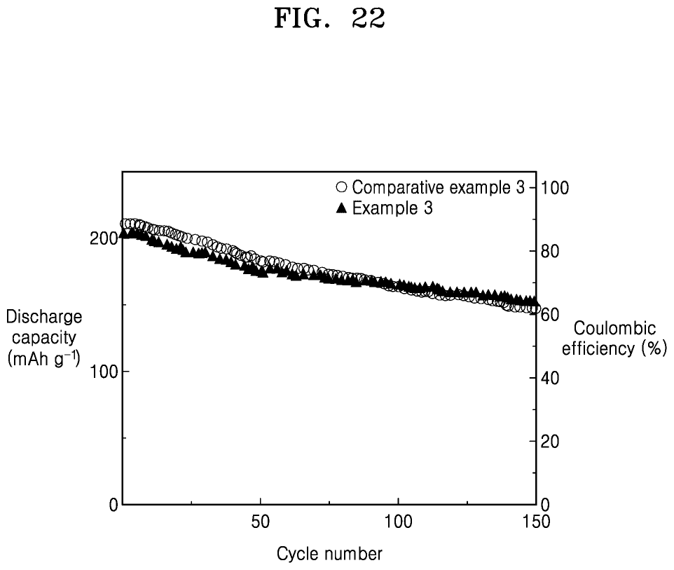

Such a charging/discharging cycle was repeated 150 times. Some of the results of the charging and discharging test at room temperature are shown in FIG. 22 and Table 4.

In FIG. 22, the left y-axis represents discharge capacity, and the right y-axis represents the charging and discharging efficiency.

The capacity retention ratio is defined by Equation 1. The charging and discharging efficiency is defined by Equation 2. In Equation 2, n is 1 to 150.

$$Capacity retention ratio ( \% ) = ( discharge capacity in {150}^{th} cycle \text{} / discharge capacity in {1}^{st} cycle ) \times 100 \qquad Equaiton 1$$

$$Charge \text{} / discharge efficiency [ \% ] = ( discharge capacity in {n}^{th} cycle \text{} / charge capacity in the {n}^{th} cycle ) \times 100 \qquad Equation 2$$

TABLE 4

| | Capacity retention rate [%] |
|---|---|
| Example 3 | 75.16 |
| Comparative Example 3 | 69.35 |

As shown in Table 4 and FIG. 22, the lithium battery of Example 3 exhibited equivalent or superior lifespan characteristics and charging and discharging efficiency compared to the lithium battery of Comparative Example 3.

Although not shown in Table 4, the lithium battery of Example 3 exhibited improved lifespan characteristics and charging and discharging efficiency even compared to the lithium battery of Comparative Example 4.

Although exemplary embodiments have been described in detail with reference to the accompanying drawings, the present inventive concept is not limited to these examples. It is obvious that those skilled in the art to which the present creative idea belongs can derive various examples of changes or modifications within the scope of the technical idea described in the claims, and these, of course, belong to the technical scope of the present creative idea.

According to an aspect, provided is a composite separator having reduced interfacial resistance, improved mechanical properties, improved heat resistance, and improved flame retardancy by including an ion-conductive composite film and a porous substrate with an anisotropic structure.

According to another aspect, provided is a composite electrolyte having reduced interfacial resistance and improved electrochemical stability by including the composite separator.

According to another aspect, provided is a lithium battery having improved heat resistance, improved flame retardancy, and improved lifespan characteristics by including the composite separator.

What is claimed is:

1. A composite separator comprising:
a first porous substrate; and an ion-conductive composite film on the first porous substrate,
the ion-conductive composite film including an oxide-based solid electrolyte and a first polymer including a carbonyl group,
wherein a content of the oxide-based solid electrolyte is greater than 80 wt % relative to a total weight of the oxide-based solid electrolyte and the first polymer, and
the first porous substrate includes a plurality of second polymer fibers aligned in a first direction.

2. The composite separator of claim 1, wherein
the oxide-based solid electrolyte includes an oxide-based solid core and a coating layer arranged on a surface of the core,
the coating layer includes a lithium-containing compound, and
the lithium-containing compound includes lithium carbonate, lithium hydroxide, or a combination thereof.

3. The composite separator of claim 2, wherein
the coating layer is arranged between the oxide-based solid electrolyte core and the first polymer, and
the coating layer is a conformal coating layer arranged along a surface contour of the oxide-based solid electrolyte core.

4. The composite separator of claim 2, wherein
when measuring an X-ray photoelectron spectroscopy (XPS) depth profile for a surface of the oxide-based solid electrolyte,
at the start of sputtering, a second oxygen peak derived from lattice oxygen (O_{lattice}) of the oxide-based solid electrolyte appearing at 527.5 eV to 530 eV is free, and
after 130 seconds from the start of sputtering, a ratio (P2/P1) of intensity (P2) of a second oxygen peak derived from lattice oxygen (O_{lattice}) of the oxide-based solid electrolyte appearing at 527.5 eV to 530 eV to intensity (P1) of a first oxygen peak derived from lithium carbonate (Li₂CO₃) appearing at 530 eV to 532.5 eV is 1 or less.

5. The composite separator of claim 2, wherein a thickness of the coating layer is in a range of about 3 nm to about 100 nm.

6. The composite separator of claim 1, wherein
the oxide-based solid electrolyte includes an oxide or phosphate including lithium and two or more types of metals other than lithium,
the oxide-based solid electrolyte includes a garnet-type solid electrolyte, a Nasicon-type solid electrolyte, a LISICON-type solid electrolyte, a perovskite-type solid electrolyte, a LiPON-type solid electrolyte, an amorphous solid electrolyte, or a combination thereof,
the oxide-based solid electrolyte includes lithium-lanthanum-zirconium-oxide (LLZO), lithium-aluminum-titanium-phosphate (LATP), lithium-lanthanum-titanium-oxide (LLTO), lithium-aluminum-germanium-phosphate (LAGP), or a combination thereof, and
a lithium content per mol of the lithium-lanthanum-zirconium-oxide is 6.8 mols or more.

7. The composite separator of claim 1, wherein
the oxide-based solid electrolyte includes a garnet-type oxide,
the garnet-type oxide includes a cubic phase, and
the garnet-type oxide is represented by Formula 1: 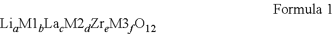
wherein, in the formulae above,
M1 is H, Fe, Ga, Al, B, Be, or a combination thereof,
M2 is Ba, Ca, Sr, Y, Bi, Pr, Nd, Ac, Sm, Gd, or a combination thereof,
M3 is Al, Ga, Ta, Nb, Hf, Ti, V, Cr, Co, Ni, Cu, Mo, W, Mg, Tc, Ru, Pd, Sc, Cd, In, Sb, Te, Tl, Pt, Si, Ir, Ru, Mn, Sn, or a combination thereof, and
6≤a≤8, 0≤b<2, 2.5≤c≤3.5, 0≤d<0.2, 1.5≤e≤2.5, and 0≤f<1.

8. The composite separator of claim 2, wherein
the first polymer includes an ester group-containing polymer, an amide group-containing polymer, or a combination thereof, and
the first polymer is a non-fluorinated polymer.

9. The composite separator of claim 1, wherein
the first polymer includes an acetate-based polymer, an acrylic-based polymer, a urethane-based polymer, or a combination thereof, and
the first polymer includes ethylene-vinyl acetate (EVA), polyvinyl acetate (PVAc), polyurethane (PU), poly(methyl methacrylate) (PMMA), polyethylene terephthalate (PET), or a combination thereof.

10. The composite separator of claim 1, wherein a thermal decomposition temperature during thermogravimetric analysis (TGA) of the first polymer is 300° C. or more.

11. The composite separator of claim 1, wherein the ion-conductive composite film is a free-standing film.

12. The composite separator of claim 1, wherein
the first porous substrate includes a porous nonwoven web including the plurality of second polymer fibers aligned in the first direction,
the first direction is perpendicular to a thickness direction of the composite separator, and
the second polymer fiber includes polyacrylonitrile (PAN), polyimide (PI), polyamide-imide (PAI), or a combination thereof.

13. The composite separator of claim 1, wherein
a tensile strength of the first porous substrate in the first direction is 50 MPa or more, and
a tensile strength of the composite separator in the first direction is 40 MPa or more.

14. The composite separator of claim 1, further comprising
a second porous substrate including a plurality of second polymer fibers aligned in a second direction distinct from the first direction,
wherein the second porous substrate is arranged on one surface of the ion-conductive composite film, or
the second porous substrate is arranged on one surface of the first porous substrate.

15. The composite separator of claim 1, wherein
a thickness ratio (T1/T2) of a thickness (T1) of the first porous substrate to a thickness (T2) of the ion-conductive composite film is greater than 1,
a thickness of the ion-conductive composite film is in a range of about 10 μm to about 50 μm, and
a thickness of the first porous substrate is in a range of about 20 μm to about 100 μm.

16. The composite separator of claim 1, wherein
a porosity of the ion-conductive composite film is less than 30%, and
a porosity of the first porous substrate is 30% or more.

17. The composite separator of claim 1, wherein a thermal shrinkage ratio of the composite separator after 30-minute exposure at 180° C. is 3% or less,
an ionic conductivity of the composite separator is 0.5 mS/cm or more at 25° C. and 1 atm, and
an electrochemical stability voltage window of the composite separator with an oxidation current of 10 μA or less is 4.5 V (vs. Li) or more.

18. A composite electrolyte comprising:
the composite separator of claim 1; and
an electrolyte arranged in the first porous substrate of the composite separator.

19. A lithium battery comprising:
a cathode; an anode; and
the composite separator of claim 1 arranged between the cathode and the anode.

20. The lithium battery of claim 19, wherein
the anode includes a lithium metal, a lithium alloy, or a combination thereof, and
the ion-conductive composite film of the composite separator is arranged adjacent to the anode.
